(19) United States
(12) Patent Application Publication
(10) Pub. No.: US 2026/0111737 A1
(43) Pub. Date: Apr. 23, 2026

(54) LOW-RANK ADAPTATION FINE-TUNING ON NEURAL PROCESSING UNIT

(71) Applicant: Intel Corporation, Santa Clara, CA (US)

(72) Inventors: Alessandro Palla, Pisa (IT); Soumendu Kumar Ghosh, Hillsboro, OR (US); Arnab Raha, San Jose, CA (US)

(73) Assignee: Intel Corporation, Santa Clara, CA (US)

(21) Appl. No.: 19/424,418

(22) Filed: Dec. 18, 2025

Related U.S. Application Data
(60) Provisional application No. 63/876,466, filed on Sep. 5, 2025.

(51) Int. Cl. G06N 3/082; G06F 9/50

(52) U.S. Cl. CPC G06N 3/082; G06F 9/5083; G06F 2209/509

(57) ABSTRACT

A neural network may be fine-tuned through a forward operation and backward operation, both of which may be offloaded to a matrix multiplication (MatMul) kernel and a differentiable kernel on a neural processing unit. For the forward operation, the MatMul kernel may compute a first partial output from an input tensor and a weight tensor of a layer, and the differentiable kernel to compute a second partial output from the input tensor and trainable tensors. An output tensor of the layer may be computed by combining the first partial output and the second partial output. For the backward operation, the differentiable kernel may compute weight gradients of a loss from a gradient of the output tensor. The trainable tensors may be updated based on the weight gradients. The layer may be modified by combining the updated trainable tensors and the weight tensor.

### CROSS-REFERENCE TO RELATED APPLICATION

This application claims the benefit of U.S. Provisional Patent Application No. 63/876,466, filed Sep. 5, 2025, and titled “LOW-RANK ADAPTATION FINETUNING ON NEURAL PROCESSING UNIT FOR ON-DEVICE AI PERSONALIZATION,” which is incorporated by reference in its entirety for all purposes.

### TECHNICAL FIELD

This disclosure relates generally to neural networks (also referred to as “deep neural networks” or “DNNs”), and more specifically, low-rank adaptation (LoRA) fine-tuning of DNNs on neural processing units (NPUs).

### BACKGROUND

DNNs are used extensively for a variety of artificial intelligence (AI) applications ranging from computer vision to speech recognition and natural language processing due to their ability to achieve high accuracy. However, the high accuracy comes at the expense of significant computation cost. Before DNNs can be used for AI tasks, they need to be trained. For some applications, pretrained DNNs need to be further fine-tuned. Training or fine-tuning DNNs has extremely high computing demands as there can be many operations as well as a large amount of data to read and write.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of an AI system, in accordance with various embodiments.

FIG. 2 illustrates an example transformer model, in accordance with various embodiments.

FIG. 3 illustrates an example CNN, in accordance with various embodiments.

FIG. 4 illustrates operations in a forward pass of a DNN training process, in accordance with various embodiments.

FIG. 5 illustrates a forward pass offloaded to a MatMul kernel of a NPU, in accordance with various embodiments.

FIG. 6 illustrates a backward pass on an NPU, in accordance with various embodiments.

FIG. 7 illustrates an MatMul operation, in accordance with various embodiments.

FIG. 8 illustrates a DNN layer with low-rank adapters, in accordance with various embodiments.

FIG. 9 illustrates a LoRA fine-tuning process on an NPU, in accordance with various embodiments.

FIG. 10 illustrates remote tensor storage, in accordance with various embodiments.

FIG. 11 illustrates a LoRA fine-tuning pipeline, in accordance with various embodiments.

FIG. 12 is a flowchart of a method of training a DNN, in accordance with various embodiments.

FIG. 13 is a block diagram of an NPU, in accordance with various embodiments.

FIG. 14 illustrates an example sparse cell, in accordance with various embodiments.

FIG. 15 illustrates an example sparse cell array, in accordance with various embodiments.

FIG. 16 illustrates an example processing element (PE), in accordance with various embodiments.

FIG. 17 is a block diagram of an example computing device, in accordance with various embodiments.

### DETAILED DESCRIPTION

The last decade has witnessed a rapid rise in AI based data processing, particularly based on DNNs. DNNs are widely used in the domains of computer vision, speech recognition, image, and video processing mainly due to their ability to achieve beyond human-level accuracy. A DNN typically includes a sequence of layers. A DNN layer may include one or more operations, such as matrix multiplication, convolution, interpolation, layer normalization, batch normalization, SoftMax operation, pooling, elementwise operation, linear operation, nonlinear operation, and so on. These operations are referred to as deep learning operations or neural network operations.

Neural network operations may be tensor operations. Input or output data of neural network operations may be arranged in data structures called tensors. Taking a convolutional layer for example, the input tensors include an activation tensor (also referred to as “input feature map (IFM)” or “input activation tensor”) including one or more activations (also referred to as “input elements”) and a weight tensor. The weight tensor may be a kernel (a 2D weight tensor), a filter (a 3D weight tensor), or a group of filters (a 4D weight tensor). A convolution may be performed on the input activation tensor and weight tensor to compute an output activation tensor in the convolutional layer.

A tensor is a data structure having multiple elements across one or more dimensions. Examples of tensors include vector (which is one-dimensional (1D) tensor), matrix (which is two-dimensional (2D) tensor), three-dimensional (3D) tensors, four-dimensional (4D) tensors, and even higher dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors. In some embodiments, a 3D tensor may have an X-dimension, a Y-dimension, and Z-dimension. The X-dimension of a tensor may be the horizontal dimension, the length of which may be the width of the tensor; the Y-dimension may be the vertical dimension, the length of which may be the height of the tensor; and the Z-dimension may be the channel dimension, the length of which may be the number of channels. The coordinates of the elements along a dimension may be integers in an inclusive range from 0 to (L−1), where L is the length of the tensor in the dimension. For instance, the x coordinate of the first element in a row may be 0, the x coordinate of the second element in a row may be 1, and so on. Similarly, the y coordinate of the first element in a column may be 0, the y coordinate of the second element in a column may be 1, and so on. A 4D tensor may have a fourth dimension, which may indicate the number of batches in the operation.

Many AI systems rely on large pretrained neural networks that deliver impressive general-purpose capabilities but lack the ability to adapt to individual users' specific needs, preferences, and contexts. While these models can excel at broad tasks, they cannot learn from personal data patterns, adapt to unique vocabularies, or optimize for individual use cases without additional training.

Currently available approaches to AI model personalization typically require full fine-tuning of neural networks, a process that involves updating millions or billions of parameters through computationally intensive training procedures. This massive computational burden has forced AI personalization into cloud-based infrastructure, where powerful graphics processing unit (GPU) clusters can handle the memory and processing requirements. However, this cloud dependency can introduce critical limitations, such as compromised user privacy through data transmission, significant latency for personalization updates, requirements for persistent connectivity, and substantial operational costs for service providers.

LoRA is a parameter-efficient fine-tuning technique that can dramatically reduce the computational requirements for neural network adaptation. Instead of updating all model parameters during training, LoRA can decompose weight updates into low-rank matrices, typically reducing trainable parameters by 90-99% while maintaining adaptation quality.

LoRA usually works by keeping the original pretrained model weights frozen and introducing small trainable adaptation matrices that capture task-specific or user-specific patterns. During inference, these adaptation matrices can be combined with the original weights to produce personalized outputs. This approach can maintain the general knowledge of the pretrained model while adding specialized capabilities through efficient parameter updates.

Despite LoRA's efficiency advantages, implementing LoRA training on edge devices can suffer from fundamental technical challenges. NPUs in consumer devices are designed primarily for inference workloads, lacking the software infrastructure, compiler toolchains, and specialized kernels for training operations. No existing framework can execute the forward and backward passes, gradient computations, and weight updates required for LoRA training directly on NPU hardware.

Furthermore, LoRA training typically requires sophisticated memory management to handle mixed execution modes where some parameters remain frozen while others are actively updated. This selective parameter updating, combined with the need for efficient gradient computation and memory allocation on resource-constrained edge devices, can create a complex technical challenge that existing AI frameworks cannot address.

A predominant approach to neural network fine-tuning has relied on cloud-based training infrastructure. Organizations typically deploy models to powerful GPU clusters in data centers, where users submit their data for model adaptation. This approach can leverage high-performance computing resources with abundant memory and processing power to handle the computational demands of full parameter updates. However, this solution can introduce significant latency, privacy concerns, and operational costs while requiring persistent connectivity.

Some currently available implementations attempted to perform lightweight training directly on-device central processing units (CPUs). These solutions typically involved simplified models or reduced precision training to accommodate the limited computational resources of consumer processors. While this approach addresses privacy and connectivity concerns, CPU-based training suffers from extremely slow convergence times and is practically limited to very small models or shallow adaptation layers.

Some advanced training frameworks implement gradient checkpointing and other memory optimization techniques to reduce the memory footprint of training. These methods trade computational time for memory efficiency by recomputing certain forward pass activations during backpropagation rather than storing them. While helpful for fitting larger models into limited memory, these techniques still require substantial computational resources and do not address the fundamental efficiency limitations.

Some systems implemented federated learning where multiple devices collaborate to train a shared model while keeping data locally. Each device can perform local training iterations and shares model updates with a central coordinator. This approach can address privacy concerns but still requires each device to perform full training computations and introduces complex coordination overhead.

There are parameter-efficient fine-tuning techniques beyond LoRA, including adapters, prompt tuning, and prefix tuning. These methods can reduce the number of trainable parameters but are primarily designed for cloud-based training environments and lack hardware-specific optimizations for edge deployment.

Currently available solutions suffer from fundamental limitations that prevent practical on-device AI personalization. Cloud-based approaches can violate privacy requirements and introduce unacceptable latency. CPU-based solutions are typically too slow for practical use. Memory optimization techniques usually require prohibitive computational resources. Federated learning can introduce coordination complexity without solving individual device efficiency. Parameter-efficient methods usually lack hardware-specific optimization for NPU deployment. None of these solutions can provide a complete framework for efficient, privacy-preserving, real-time model personalization directly on consumer devices equipped with specialized AI acceleration hardware. This gap necessitated the development of a novel approach specifically designed for NPU-accelerated LoRA training.

Embodiments of the present disclosure may improve on at least some of the challenges and issues described above by providing a method for performing LoRA fine-tuning of neural network models directly on NPUs. In an example, differentiable LoRA kernels optimized for NPUs may be used to enable fine-tuning with a mixed Graph-Eager execution mode. During fine-tuning, original model weights may be frozen to improve inference performance and memory efficiency and enable efficient, on-device AI model personalization. This disclosure introduces a comprehensive method for performing LoRA fine-tuning of neural network models directly on NPUs, enabling efficient, privacy-preserving, on-device AI model personalization without reliance on cloud infrastructure.

In various embodiments of the present disclosure, a DNN model (e.g., a pretrained DNN model) may be fine-tuned based on low-rank adapters. For instance, two low-rank adapters may be introduced into a pretrained DNN layer. The pretrained DNN layer may have a pretrained weight tensor, which may be frozen during the fine-tuning process. The low-rank adapters may have trainable weights that can be optimized during the fine-tuning process. The low-rank adapters may be referred to as LoRA adapters, low-rank tensors, or LoRA weight tensors. The DNN layer may be fine-tuned through a forward pass and backward pass. Each pass may have a layer path with the pretrained weight tensor and a LoRA path with the LoRA weight tensors. The layer path of the forward pass or backward pass may be offloaded to a matrix multiplication (MatMul) kernel on an NPU. For instance, all the operators in the layer path of the forward pass or backward pass may be mapped to the MatMul kernel, and the MatMul kernel may execute all the operators in the layer path of the forward pass or backward pass. The LoRA path of the forward pass or backward pass may be offloaded to a differentiable kernel on the NPU. For instance, all the operators in the LoRA path of the forward pass or backward pass may be mapped to the differentiable kernel, and the differentiable kernel may execute all the operators in the LoRA path of the forward pass or backward pass. For the forward pass, the MatMul kernel may compute a first partial output from an input tensor and the pretrained weight tensor of the layer. The input tensor may be a training sample or a DNN intermediate tensor computed from the training sample. The differentiable kernel may compute a second partial output from the input tensor and trainable tensors. An output tensor of the layer may be computed by combining the first partial output and the second partial output. A training loss may be computed from the output tensor and one or more reference values. An output gradient may be determined based on the loss. For the backward pass, the MatMul kernel may perform computations based on the output gradient and the pretrained weight tensor, and the differentiable kernel may perform computations based on the output gradient and LoRA weight tensors. The differentiable kernel may compute weight gradients for the LoRA weight tensors, respectively. The NPU may also execute an optimization operator to update the LoRA weight tensors based on the weight gradients. The updated LoRA weight tensors may be combined with the pretrained weight tensor. For instance, the NPU may perform an MatMul operation on the updated LoRA weight tensors and add the result of the MatMul operation and the pretrained weight tensor to compute a new weight tensor. The layer may be modified by replacing the weight tensor with the new weight tensor. The fine-tuned DNN may be deployed to perform AI tasks.

This disclosure provides a technique that can solve the fundamental problem of enabling efficient, privacy-preserving AI personalization directly on consumer devices by creating the first comprehensive framework for LoRA-based neural network training on NPU hardware. By bringing training capabilities to the edge, it can eliminate the need for cloud dependency while enabling real-time, continuous AI personalization that adapts to individual users without compromising their privacy or requiring persistent connectivity.

Different from currently available fine-tuning approaches require significant compute and memory resources, often relegating training tasks to cloud infrastructure, the LoRA fine-tuning approach in this disclosure can allow users to adapt pretrained models locally on their device using NPU acceleration, reducing latency, preserving privacy, and eliminating the need for continuous connectivity. Currently available solutions usually require developing a complete NPU training compiler tool chain, hardware-specific optimization strategies for LoRA operations, novel memory management techniques for mixed training and inference workloads, seamless integration layer between high-level frameworks and low-level NPU APIs, and efficient deployment mechanisms that fold trained adaptations into production models. The technique in this disclosure can solve these interconnected problems by creating the first comprehensive framework for LoRA-based neural network training directly on NPU hardware, enabling efficient, private, and real-time AI model personalization at the edge.

Currently available DNN fine-tuning approaches typically require updating millions or billions of parameters, creating prohibitive computational and memory demands that force deployment to powerful cloud-based GPU clusters. This dependency can introduce significant latency, privacy vulnerabilities, operational costs, and connectivity requirements that limit real-time personalization capabilities. The method in this disclosure can fundamentally transform this paradigm by leveraging the specialized computational architecture of NPUs to perform efficient LoRA-based training directly on consumer devices. LoRA can dramatically reduce the computational burden by decomposing weight updates into low-rank matrices, typically reducing trainable parameters by 99% while maintaining model adaptation quality. However, implementing LoRA training on NPU hardware usually requires solving multiple novel technical challenges including the development of differentiable kernels optimized for NPU instruction sets, creation of a complete training compiler toolchain, and design of efficient memory management strategies for mixed training and inference workloads.

The approach in this disclosure can capture forward and backward passes, loss computation, and weight updates using PyTorch and a custom compiler toolchain to generate NPU-executable code. A key feature may be the design of a differentiable LoRA-specific kernel optimized for mixed Graph-Eager execution modes, allowing fine-grained control over updates while freezing the base model weights for efficiency. LoRA weights may be updated using remote tensors on the NPU, and the entire training and inference flow may be managed through a PyTorch-like API. For deployment, the trained LoRA weights can be folded into the model and exported using OpenVINO GenAI for highly efficient runtime performance. This disclosure provides a full training pipeline targeting NPUs, including forward pass, backward pass, and optimizer execution, which can be implemented using L0 driver APIs. This method can provide memory-efficient training using remote tensor allocation directly in NPU memory space and enable seamless integration with PyTorch through TorchDynamo and FX tracing for user-friendly model compilation and execution.

This disclosure provides a transformative breakthrough that can enable the first comprehensive neural network training framework on consumer NPU hardware. By implementing LoRA-based fine-tuning directly on NPUs, it can fundamentally shift AI personalization from cloud-dependent to autonomous on-device learning. The technical achievement can solve multiple interconnected challenges including differentiable NPU kernels, efficient memory management, and seamless framework integration. This can enable unprecedented privacy-first AI personalization across diverse applications while eliminating cloud dependency and operational costs. Strategically, the method in this disclosure can uniquely support both inference and training workloads. It can create a foundation for future edge AI innovations while addressing critical adoption barriers through PyTorch compatibility and automated deployment pipelines. The method in this disclosure can enable entirely new business models and user experiences, allowing organizations to offer deeply personalized AI services without infrastructure costs or privacy risks. It represents a fundamental enabler for the next generation of intelligent, adaptive, and privacy-preserving AI systems that evolve continuously with users while maintaining complete data control.

For purposes of explanation, specific numbers, materials and configurations are set forth in order to provide a thorough understanding of the illustrative implementations. However, it can be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations are described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

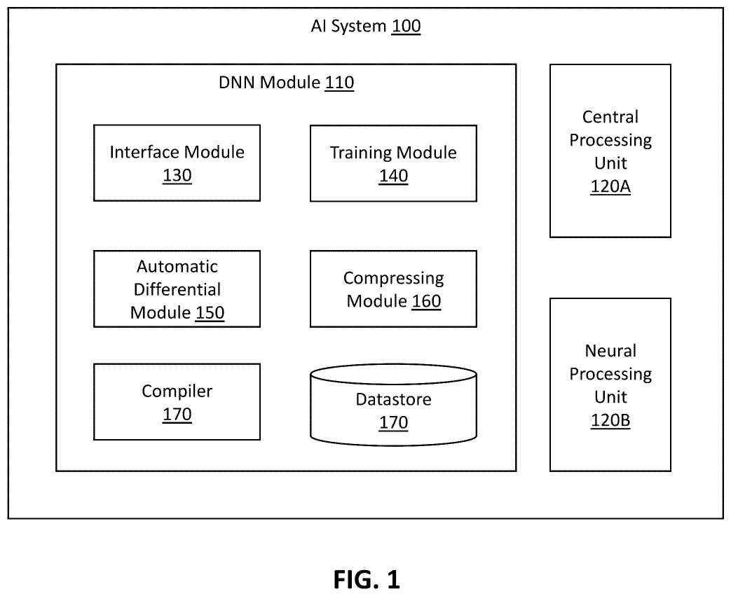

FIG. 1 is a block diagram of an AI system 100, in accordance with various embodiments. The AI system 100 includes a DNN module 110, a CPU 120A, and an NPU 120B. In other embodiments, alternative configurations, different or additional components may be included in the AI system 100. For instance, the AI system 100 may include multiple CPUs or NPUs. Also, the AI system 100 may include other types of processing units, such as GPU. Further, functionality attributed to a component of the AI system 100 may be accomplished by a different component included in the AI system 100 or a different system. For instance, functionality attributed to the DNN module 110 may be accomplished by a module or system on the CPU 120A or NPU 120B.

The DNN module 110 facilitates generation and deployment of DNNs. In some embodiments, the DNN module 110 may train and fine-tune DNNs. The DNN module 110 may offload operations in DNN training and fine-tuning processes to the NPU 120B. The DNN module 110 may also deploy trained or fine-tuned DNNs for use in AI applications (e.g., language processing, image classification, motion planning, etc.). In some embodiments, the DNN module 110 may facilitate deployment of the DNNs using the NPU 120B. For instance, the DNN module 110 may offload operations for DNN inference to the NPU 120B. DNN inference may be a process of executing a trained or fine-tuned DNN for performing an AI task. In other embodiments, the DNN module 110 may distribute trained or fine-tuned DNNs to devices or systems which may use the DNNs to perform tasks for which the DNNs were trained.

As shown in FIG. 1, the DNN module 110 includes an interface module 130, a training module 140, a automatic differential module 150, a compressing module 160, a compiler 170, and a datastore 180. In other embodiments, alternative configurations, different or additional components may be included in the DNN module 110. Further, functionality attributed to a component of the DNN module 110 may be accomplished by a different component included in the DNN module 110 or a different module or system. In some embodiments, the DNN module 110 may be executed on a computer system including the AI system 100. The DNN module 110 may run on an operation system of the computer system. The DNN module 110 may use a processing unit in the computer system, such as the CPU 120A or another CPU.

The interface module 130 facilitates communications of the DNN module 110 with other modules or systems. In some embodiments, the interface module 130 establishes communications between the DNN module 110 with an external database to receive datasets that can be used to train DNNs or fine-tune DNNs. The interface module 130 may also receive datasets to be processed by trained or fine-tuned DNNs for performing AI tasks. In some embodiments, the interface module 130 may receive requests for training, fine-tuning, or deploying DNNs. The requests may be received from applications executed on the same device as the DNN module 110. For instance, the DNN module 110 may be executed on a computing device, and the requests may be received from applications (e.g., word processing applications, image processing applications, browser applications, etc.) running on an operation system of the computing device. In some embodiments, the interface module 130 may provide a user interface, e.g., a graphical user interface, through which users may submit request for training DNNs. For instance, the user interface may allow users to specific training hyperparameters, such as rank for LoRA fine-tuning, scaling factor, learning rate, epochs, and so on. The interface module 130 may forward a request or dataset for training or fine-tuning a DNN to the training module 140. In some embodiments, the interface module 130 may distribute trained or fine-tuned DNNs to other systems, e.g., computing devices configured to apply DNNs to perform AI tasks.

The training module 140 trains and fine-tunes DNNs. For instance, the training module 140 may fine-tune pretrained DNNs based on LoRA. The training module 140 may introduce low-rank adapters and train the low-rank adapters during a fine-tuning process. The low-rank adapters may be two trainable tensors. The pretrained weights of the DNN may be frozen and combined with the trained low-rank adapters to produce new weights. In various embodiments, a fine-tuning process is considered as a training process. For instance, the fine-tuning process may be a retraining or further training process.

In some embodiments, the training module 140 may use a training data set to train a DNN. The training module 140 may generate the training dataset. The training dataset may include training samples and reference values. A training sample may be an input to the DNN. The reference values may represent correct predictions made by the DNN from the training samples. The reference values may be ground-truth values or verified values. In an example where the training module 140 trains an DNN to recognize objects in images, the training module 140 may generate a training dataset that includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the training module 140 to validate performance of a trained DNN. The data portion of the training dataset not including the validation subset may be used to train the DNN.

The training module 140 may determine hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, LoRA rank, scaling factor, learning rate, etc. A batch size defines the number of training samples used for a single update of the DNN's internal parameters. The batch size is the same as or smaller than the number of samples in the training dataset. The training dataset can be divided into one or more batches. The number of batches may define the number of updates of the DNN's internal parameters for a single epoch. The number of epochs may define how many times the entire training dataset is passed forward and backwards through the entire network. One epoch means that each training sample in the training dataset has had an opportunity to update the parameters inside the DNN. The number of epochs may be 1, 5, 10, 50, 100, 500, 1000, or even larger. An epoch may include one or more batches. The training module 140 may train the DNN for a predetermined number of epochs. After the training module 140 finishes the predetermined number of epochs, the training module 140 may stop updating the parameters in the DNN. The DNN having the updated parameters is referred to as a trained DNN. The LoRA rank may control adapter size and capacity. For instance, the rank may define a dimension of a trainable tensor. The scaling factor may normalize update magnitude. The learning rate may determine how much trainable LoRA weights are adjusted during each optimization step.

In some embodiments, the training module 140 may define the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully-connected layers, normalization layers, SoftMax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between two convolution layers. A fully-connected layer involves weights, biases, and neurons. It connects neurons in one layer to neurons in another layer. It is used to classify images between different categories by training. In the process of defining the architecture of the DNN, the training module 140 also adds an activation function to a hidden layer or the output layer. An activation function of a layer transforms the weighted sum of the input of the layer to an output of the layer. The activation function may be, for example, a ReLU activation function, a tangent activation function, or other types of activation functions.

To train a DNN, the training module 140 inputs the training samples into the DNN. The training module 140 modifies the parameters inside the DNN (“internal parameters of the DNN”) to minimize the error between the DNN's prediction and reference values. The reference values may be used to measure the loss during training. The reference values may be actual values (e.g., values indicating ground truth) or values verified to be accurate or true. The internal parameters may be learnable parameters whose values can be optimized by training the DNN. The internal parameters include weights, such as weights in convolutional filters, weights in MHA layers, and so on. For LoRA fine-tuning, the pretrained weights of the DNN may be frozen so that they can remain the same during the training process, and the LoRA adapter weights may be adjusted based on the loss.

In some embodiments, the training module 140 may define stages in the training process. For example, for each training sample or each epoch, the training module 140 defines a forward pass, a backward pass, and an optimization process. During the forward pass, data propagates forward through the DNN layers. For instance, data (e.g., activations) pass from the input layer to hidden layers, then to the output layer. An output of the DNN, which indicates a prediction of the DNN, may be generated at the last layer, which may be the output layer of the DNN. This part of the forward pass may be an inference process in which the DNN is executed to process the training sample and make a prediction. The inference process may be denoted as outₙₙ=f_{w}(x)=ƒ(x, w), where outₙₙ is the DNN output, f is the network architecture, and w are the internal parameters (e.g., weights). To fine-tune a DNN layer using LoRA adapters, the forward pass may include a LoRA path in addition to a layer path. The layer path may include computations on the input tensor and pretrained weight tensor of the layer. The LoRA path may include computations on the input tensor and the LoRA adapters, i.e., the LoRA weight tensors. The layer path may produce a partial output. The LoRA path may produce another partial output. The two partial outputs may be added to produce a final output tensor of the layer.

The training module 140 may apply gradient descent to train DNNs. After the DNN output is generated, a loss may be computed. The training module 140 may define a loss function that can measure a loss during forward pass, e.g., through a forward loss operator. The loss may measure the difference between the DNN output and the actual values. It may provide a measure of error that an optimization algorithm can use to update weights (e.g., LoRA adapter weights) during the optimization process. In some embodiments, the loss function 420 may be selected, e.g., by the training module 140, from various types of loss functions, such as mean square error (MSE), cross-entropy loss, mean absolute error (MAE), Huber loss, Hinger loss, cosine similarity, Poisson loss, and so on. The computation of the loss function may be denoted as

$$L = \frac{1}{N} \sum loss ( {f}_{w} ( x ) , {y}_{ref} ) ,$$

where is the loss, y_{ref} is the reference value(s), and N is the number of training samples in a batch.

During the backward pass, data propagates backwards and the DNN is run backwards. The data may be gradients computed using the loss. A gradient may be a partial derivative of a function (e.g., a loss function) with respect to its inputs, which may be the slope of the function. Gradients computed during the backward pass may measure the changes in weights with respect to the change in error or loss. Gradients computed during the backward pass may include output gradients, input gradients, and weight gradients. An output gradient of a layer may be a gradient with respect to the layer output and may be denoted as

$$\frac{\partial L}{\partial y} .$$

An input gradient of a layer may be the gradient with respect to the layer input and may be denoted as

$$\frac{\partial L}{\partial x} .$$

A weight gradient may be a gradient of each parameter with respect to the layer output and may be denoted as

$$\frac{\partial L}{\partial {W}_{i}} ,$$

where i is the index of the layer. The training module 140 may define a MatMul operation to compute the weight gradient and another MatMul operation to compute the input gradient. The input gradient may be defined as

$$\frac{\partial L}{\partial x} = \frac{\partial L}{\partial y} * \frac{\partial y}{\partial x} ,$$

where x is the layer input, Wᵢ is the layer parameters, as y is the layer output. The weight gradient may be defined as

$$\frac{\partial L}{\partial {W}_{i}} = \frac{\partial L}{\partial y} * \frac{\partial y}{\partial {W}_{i}} .$$

In some embodiments, the layer being executed in the forward pass may be denoted as y=x*Wᵢ. Therefore, the function for the input gradient may become ∇ₓ_{ᵢ}L=∇_{y}L*∇ₓ_{ᵢ}y=∇_{y}L*W^{T}, where

$${∇}_{{x}_{i}} L = \frac{\partial L}{\partial x} , {∇}_{y} L = \frac{\partial L}{\partial y} , and {∇}_{{x}_{i}} y = \frac{\partial y}{\partial x} = {W}_{i} = {W}^{T} .$$

The function for the weight gradient may become ∇_{w}L=∇_{y}L*∇_{W}y=x^{T}*∇_{y}L, where

$${∇}_{W} L = \frac{\partial L}{\partial {W}_{i}} , {∇}_{y} L = \frac{\partial L}{\partial y} , and {∇}_{W} y = \frac{\partial y}{\partial {W}_{i}} = x = {x}^{T} \cdot {x}^{T}$$

may be an input tensor (e.g., the activation tensor) of the layer. W^{T} may be a weight tensor of the lawyer. In some embodiments, ∇_{W}L may be a tensor having the same spatial shape as W^{T}. The input gradient may be propagated to the previous layer. The weight gradient may be used to update the parameters through an optimization process.

During the optimization process, weights may be updated using an optimization function. The training module 140 may define the optimization function. An example optimization function may be:

$${W}_{i}^{N + 1} = {W}_{i}^{N} - λ {∇}_{{W}_{i}} L ,$$

where γ is the learning rate,

$${∇}_{{W}_{i}} L = \frac{\partial L}{\partial {W}_{i}} ,$$

N is the index of the current batch, and N+1 is the index of the next batch.

In some embodiments (e.g., embodiments of LoRA fine-tuning), the backward pass may include a layer path and a LoRA path. The LoRA path may be used for updating LoRA adapter weights. Two weight gradients may be determined for the two LoRA weight tensors, respectively. Each LoRA weight tensor may be updated based on the corresponding weight gradient and the learning rate. In some embodiments (e.g., embodiments of LoRA fine-tuning), weight gradient for the original weight tensor of the DNN layer is not determined as the original weight tensor is frozen.

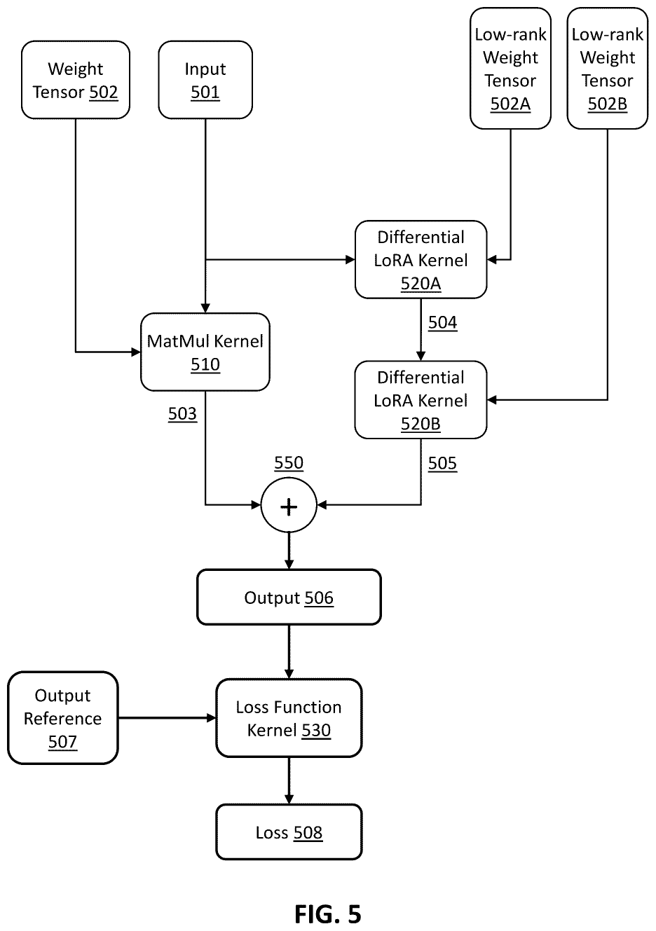

In some embodiments, the training module 140 may offload MatMul operation in the forward pass and backward pass to a MatMul kernel on the NPU 120B. The MatMul kernel can perform MatMul operations on tensors of various spatial shapes and dimensions. That way, the MatMul kernel can perform the MatMul operations in the forward pass (e.g., the MatMul operations in the layer) as well as the MatMul operations in the backward pass (e.g., the MatMul operations for computing input gradient and weight gradient). The training module 140 may also offload LoRA paths in the forward pass and backward pass to a differential kernel on the NPU 120B. The differential kernel may perform computations on input tensor and LoRA adapter weights during the forward pass. The differential kernel may also compute weight gradients during the backward pass. Certain aspects regarding forward pass and backward pass are described below in conjunction with FIGS. 5, 6, and 9.

In some embodiments, the training module 140 may deploy the automatic differential module 150 to compute the output gradient during the backward pass. The training module 140 may leverage the functionality of the automatic differential module 150 to integrate automated differentiation and seamless gradient tracking into the training flow, thereby reducing the need for manual configuration of backward computations. The training module 140 may instruct the compiler 170 to integrate the automatic differential module 150 into executable instructions (e.g., codes) for performing the training process. In some embodiments, the NPU 120B may automatically run the functions in the automatic differential module 150 when it executes the executable instructions. In other embodiments, the automatic differential module 150 may use the CPU 120A instead of the NPU 120B. The automatic differential module 150 provides automatic differentiation capabilities, allowing it to offload both forward and backward passes of computation intensive operations to the NPU 120B seamlessly, while leaving the rest of the control flow to be handled by the CPU 120A. The integration of the automatic differential module 150 can enable end-to-end gradient tracking and updating on the NPU without requiring users to manually configure each layer's backward computations, making it more accessible and efficient for real-time training applications.

The automatic differential module 150 can automatically compute derivatives of tensor operations. In some embodiments, the automatic differential module 150 may track tensor operations during the training process, such as the MatMul operation(s) during the forward pass. For instance, the automatic differential module 150 may build a dynamic computational graph that tracks the MatMul operation(s). The automatic differential module 150 may also record the inputs and outputs of the MatMul operation(s). The automatic differential module 150 may use a chain rule to calculate gradients of the output with respect to all tensors that require gradients. An example of the automatic differential module 150 is PyTorch Autograd. The functionality of the automatic differential module 150 may allow the training loop to compute gradients and update weights without recompiling the DNN. The training module 140 may offload compute intensive operations (e.g., the MatMul operations) to the NPU 120B seamlessly, while leaving the rest of the control flow to be handled by the CPU 120A. By integrating the automatic differential module 150, the NPU 120B can perform end-to-end gradient tracking and updating without requiring users to manually configure each layer's backward computations, making it more accessible and efficient for real-time training applications. This approach can retain the speed and efficiency of the NPU 120B, as the forward and backward passes can be executed natively on the NPU 120B, while weights can remain accessible and mutable in the memory of the NPU 120B.

In some embodiments, the training module 140 facilitates mixed-precision training on NPU. For instance, BF16 (brain floating-point or bfloat16) and FP16 (half-precision floating-point) formats may be used to significantly enhance computational efficiency and reduce memory bandwidth requirements. BF16 and FP16 can be ideal for training DNNs, as they provide a balance between precision and performance. Using these formats allows for faster matrix multiplications and gradient calculations with reduced memory footprint, without a substantial loss in accuracy. The NPU hardware may include dedicated support for BF16 and FP16 operations, enabling high-speed tensor calculations directly in these formats. For instance, the NPU may include one or more memories that can store floating-point data. Also, the NPU may include multipliers, adders, data paths, or other components that support floating-point data formats. Furthermore, the NPU's architecture may be optimized to handle accumulation in higher precision, which mitigates the effects of numerical instability often associated with lower-precision formats. This hardware-based support for mixed-precision training can maximize the throughput of matrix multiplication operations, enhances power efficiency, and accelerates training speeds, making it possible to deploy sophisticated neural network training workflows on resource-constrained edge devices.

In some embodiments, the training module 140 may also verify accuracy of DNNs after training or fine-tuning. In some embodiments, the training module 140 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the training module 140 may determine an accuracy score measuring the precision, recall, or a combination of precision and recall of the DNN. The training module 140 may use the following metrics to determine the accuracy score: Precision=TP/(TP+FP) and Recall=TP/(TP+FN), where precision may be how many the DNN correctly predicted (TP or true positives) out of the total it predicted (TP+FP or false positives), and recall may be how many the DNN correctly predicted (TP) out of the total number of objects that did have the property in question (TP+FN or false negatives). The F-score (F-score=2*PR/(P+R)) unifies precision and recall into a single measure.

The training module 140 may compare the accuracy score with a threshold score. In an example where the training module 140 determines that the accuracy score of the DNN is less than the threshold score, the training module 140 instructs the training module 140 to retrain the DNN. In one embodiment, the training module 140 may iteratively retrain the DNN until the occurrence of a stopping condition, such as the accuracy measurement indication that the DNN may be sufficiently accurate, or a number of training rounds having taken place.

The compressing module 160 compresses DNNs. For instance, the compressing module 160 may add compressing operations to DNN layers to reduce computational complexity or memory usage. A compressing operation may modify weights in a DNN layer. The modification may be done before, during, or after training. In some embodiments, the compressing module 160 may select one or more layers in a DNN and modify each selected layer with a compressing operation. For instance, the compressing module 160 may select computationally complex layers, such as a layer with a large number of weights. For a compressing operation of a layer or of a type of layer, the compressing module 160 may determine a weight threshold that would not cause a loss of the accuracy of the DNN to exceed an accuracy loss constraint. A compressing operation may modify weights having absolute values above the weight threshold to lower-precision values or zeros and leave the other weights unchanged.

After compressing a DNN, the compressing module 160 may instruct the training module 140 to fine-tune the DNN. In such fine-tuning process, the values of the unpruned weights in the DNN may be modified, while the values of the pruned weights (i.e., zero) are not changed. For instance, the compressing module 160 may place a mask over a pruned weight block and the mask can prevent values in the pruned weight blocks from being changed during the fine-tuning process. In other embodiments, the values of all weights, including the pruned weights, may be changed during the fine-tuning process. After the fine-tuning process, the compressing module 160 may perform a new pruning process, e.g., by changing more weights to zero. In some embodiments, the weight pruning process may be repeated multiple times before the fine-tuning process is done. In some embodiments, the number of epochs in the fine-tuning process may be different from the number of epochs in the training process in which the pre-pruning values of the weights are determined. For instance, the fine-tuning process may have less epochs than the training process. In an example, the number of epochs in the fine-tuning process may be relatively small, such as 2, 3, 4, 5, and so on.

The compiler 170 compiles DNNs to generate instructions (e.g., configuration parameters, etc.) that can be executed by the CPU 120A or NPU 120B to carry out neural network operations in DNNs, either for training purposes or deployment purposes. In some embodiments, the compiler 170 may generate a graph representing a DNN. The graph may include nodes and edges. A node may represent a specific neural network operation in the DNN. An edge may connect two nodes and represent a connection between the two corresponding neural network operations. In an example, an edge may encode a tensor that flows from one of the neural network operations to the other neural network operation. The tensor may be an output tensor of the first neural network operation and an input tensor of the second neural network operation. The edge may encode one or more attributes of the tensor, such as size, shape, storage format, and so on. The compiler 170 may use the graph to generate executable DNNs. For instance, the compiler may generate computer program instructions for executing DNNs.

In some embodiments, the compiler 170 may generate configuration parameters that may be used to configure components of the NPU 120B for DNN executions. The configuration parameters may be stored in one or more configuration registers associated with the components of the NPU 120B. In some embodiments, the compiler 170 may compile a DNN before the DNN is trained. During the training process, the compiler 170 may perform no compilation. The compiler 170 may recompile the DNN after it is trained. The compiler 170 may perform different complications before and after the training. For instance, the compiler 170 may compile the DNN before training based on the condition that internal parameters of the DNN are to be changed during the training process. The compiler 170 may compile the DNN after training based on the condition that internal parameters of the DNN would remain the same.

In some embodiments, the compiler 170 may generate a plurality of executable files for implementing a LoRA fine-tuning process on the NPU 120B. For instance, the compiler 170 may generate a forward pass executable file, loss forward executable file, loss backward executable file, backward pass executable file, and optimization executable file. The forward pass executable file may be executed by the NPU 120B to perform a forward pass. The loss forward executable file may be executed by the NPU 120B to compute a training loss. The loss backward executable file may be executed by the NPU 120B to compute gradients, e.g., output gradient, input gradient, and weight gradient. The backward pass executable file may be executed by the NPU 120B to perform a backward pass. The optimization executable file may be executed by the NPU 120B to update LoRA adapter weights. An executable file may be a binary file including instructions that can be executed by the NPU 120B.

The datastore 180 stores data received, generated, used, or otherwise associated with the DNN module 110. For example, the datastore 180 stores the datasets used by the training module 140 to train or fine-tune DNNs. The datastore 180 may also store data generated by the training module 140, such as the hyperparameters for training DNNs, internal parameters of trained DNNs (e.g., weights, etc.), and so on. The datastore 180 may also store data generated by the compressing module 160, such as compressed weights, and so on. The datastore 180 may store instructions, configuration parameters, or other data generated by the compiler 170. The datastore 180 may include one or more memories. In the embodiment of FIG. 1, the datastore 180 is a component of the DNN module 110. In other embodiments, the datastore 180 may be external to the DNN module 110 and communicate with the DNN module 110 through a network.

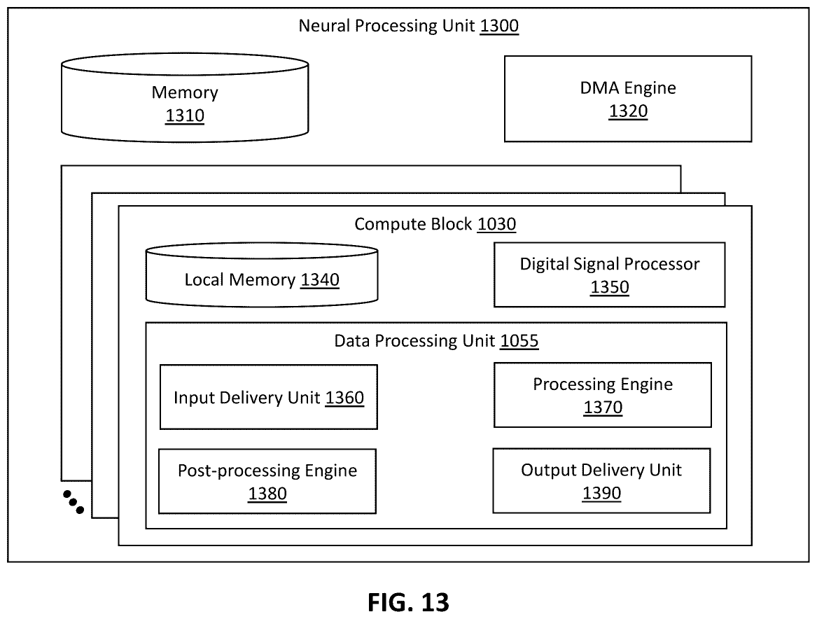

The CPU 120A may be a general-purpose processing unit. The NPU 120B may be designed for accelerating DNNs. In some embodiments, the NPU 120B may leverage parallel processing or data sparsity to accelerate DNN executions. The CPU 120A may be used for controlling DNN training or deployment. For instance, the training module 140 or compiler 170 may run using the CPU 120A. In some embodiments (such as embodiments, the AI system 100 is part of a computing device, such as personal computer, smart phone, tablet, etc.), the CPU 120A may also be used to run other applications, such as word processing applications, image processing applications, browsing applications, and so on. The NPU 120B may be used for performing compute intensive operations (e.g., the MatMul operations described above) for training or deploying DNNs. The CPU 120A and NPU 120B may be collectively referred to as heterogenous processing units 120, individually referred to as “heterogenous processing unit 120.” The heterogenous processing units 120 may be implemented in separate chips. For example, each heterogenous processing unit 120 may be implemented as a separate chip. Certain aspects of NPU are described below in conjunction with FIGS. 13-16.

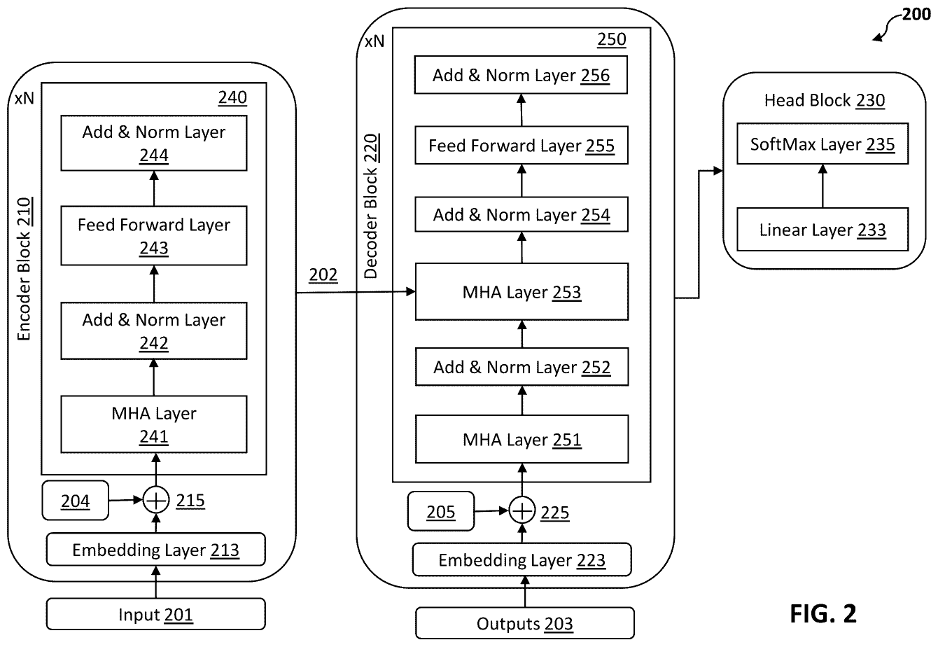

FIG. 2 illustrates an example transformer model 200, in accordance with various embodiments. The transformer model 200 may transform input sequences into output sequences. In some embodiments, the transformer model 200 is a DNN that can learn context and meaning by tracking relationships in sequential data, such as sequential words in a sentence, sequential audio signals, sequential images, and so on. In an example, the transformer model 200 may be at least part of an LLM. The transformer model 200 may be an example of the DNNs described herein. The transformer model 200 may be trained by the training module 140 in FIG. 1. As shown in FIG. 2, the transformer model 200 includes an encoder block 210, a decoder block 220, and a head block 230. In other embodiment, different or additional components may be included in the transformer model 200. Further, functionality attributed to a component of the transformer model 200 may be accomplished by a different component included in the transformer model 200 or a different model or module.

The encoder block 210 receives input sequences and generates matrix representations of the input sequences. In the embodiments of FIG. 2, the encoder block 210 receives an input 201 and generates an encoder output 202. The input 201 may be an input prompt. In some embodiments, the input 201 may include one or more input tokens, such as words, phrases, sentences, images, audio signals, other types of input tokens, or some combination thereof. In an example, the input 201 may include a prompt received from a user of the transformer model 200. The prompt may include a question or request made by the user. A word in the prompt may be an input token. The encoder output 202 may include one or more vectors that are contextualized representations of the input 201. Each vector in the encoder output 202 may represent a token in the input 201 with contextual understanding.

The encoder block 210 includes an embedding layer 213, a positional encoding layer 215, and a plurality of layers 240 (individually referred to as “layer 240”). In other embodiments, the encoder block 210 may have different, fewer, or more components. Also, the arrangement of the components in the encoder block 210 may be different from the arrangement shown in FIG. 2. For the purpose of illustration, the encoder block 210 has N layers in FIG. 2, where N is an integer. Each layer 240 may include one or more neural network operations. The layers 240 may transform a sequence of embeddings into a representation that encapsulates the learned information from the input 201. Different layers 240 may have different internal parameters, e.g., different weights, bias, or other types of internal parameters. In some embodiments, the layers 240 have identical components. The components in a layer 240 may be layers and may also be referred to as sub-layers of the layer 240. As shown in FIG. 2, a layer 240 includes four sub-layers: a multi-head attention (MHA) layer 241, an add & norm layer 242, a feed forward layer 243, and another add & norm layer 244.

The decoder block 220 iteratively generates outputs 203 using encoded representations generated by the encoder block 210. The decoder block 220 includes an embedding layer 223, a positional encoding layer 225, and a plurality of layers 250 (individually referred to as “layer 250”). For the purpose of illustration, the decoder block 220 has N layers in FIG. 2, where N is an integer. In the embodiments of FIG. 2, the number of layers 250 in the decoder block 220 is the same as the number of layers 240 in the encoder block 210. In other embodiments, the number of layers 250 in the decoder block 220 may be different from the number of layers 240 in the encoder block 210. Each layer 250 may include one or more neural network operations. Different layers 250 may have different internal parameters. In some embodiments, the layers 250 may have identical components. The components in a layer 250 may be layers and may also be referred to as sub-layers of the layer 250. As shown in FIG. 2, a layer 250 includes six sub-layers: an MHA layer 251, an add & norm layer 252, another MHA layer 253, another add & norm layer 254, a feed forward layer 255, and another add & norm layer 256.

In some embodiments, a sequence of inference stages is performed in the decoder block 220 using encoder outputs, e.g., the encoder output 202. A matrix may be predicted through each inference stage. The outputs 203 may include a plurality of matrices. Each matrix may be further processed in the head block 230 to predict a token. The plurality of matrices may be used to predict a sequence of tokens. For the first inference stage, the decoder block 220 may receive one or more start tokens as input tokens and compute a first matrix from the input tokens and the output of the encoder block 210. The first matrix may be used by the head block 230 to predict a first token. The predicted token may be used as a new input token, in addition to the start token(s), in the second inference stage. Similarly, a second token may be predicted through the second inference stage and may be used in the third inference stage. This iteration may continue till all the inference stages are complete.

The head block 230 receives the output of the decoder block 220 and processes it in a linear layer 233 and a SoftMax layer 235. A linear operation may be performed on the output of the decoder block 220 in the linear layer 233. The linear operation may include a multiplication of the output of the decoder block 220 with a weight matrix. The output of the linear layer 233 may be a vector. In some embodiments, the head block 230 may function as a classifier. The number of data elements in the vector computed in the linear layer 233 may depend on the number of classes involved. In an example where there are M classes, where M is an integer, the vector computed in the linear layer 233 may have M data elements representing the prediction for the M classes, respectively.

The output of the linear layer 233 may be input into the SoftMax layer 235. A SoftMax function may be applied on the output of the linear layer 233 to compute probability scores. A probability score may have a value in the range from 0 to 2. In some embodiments, a probability value is computed for each data element in the vector computed in the linear layer 233. The highest one of the probability scores may be the key. The corresponding index of the key may point to the token that the transformer model 200 predicts as the next in the sequence. The final output of the transformer model 200 may be the sequence of predicted tokens. In some embodiments, the head block 230 may be a language modeling head.

An embedding layer (e.g., the embedding layer 213 or the embedding layer 223) converts an input of the embedding layer (e.g., the input 201 or the outputs 203) into one or more embeddings. An embedding may be a vector, which is also referred to as an embedding vector or a vector embedding. The vector embedding may include a sequence of data elements. In some embodiments, the embedding layer 213 may generate a plurality of embeddings, each of which may be converted from a different input token in the input 201. The embeddings may capture the semantic meaning of the tokens in the input 201. The embeddings may be numerical representations that capture the relationships or meanings of words, phrases, or other data types. In an example where the input 201 is a prompt including a sequence of words, the embedding layer 213 may generate an embedding from each word in the input 201. The embedding layer 223 in the decoder block 220 may generate a plurality of embeddings from tokens received by the decoder block 220 in a similar manner as the embedding layer 213.

A positional encoding layer (e.g., the positional encoding layer 215 or the positional encoding layer 225) performs positional encoding on embeddings generated in the corresponding embedding layer. In some embodiments, the positional encoding layer may apply one or more positional encoding vectors (e.g., a positional encoding vector 204 or positional encoding vector 205) on vector embeddings from the corresponding embedding layer to generate new vector embeddings that represent the embeddings with positional context. The positional encoding vector may encode information about the position of the embedding in a sequence of embeddings. In some embodiments, the positional encoding layer performs an addition operation on a positional encoding vector and a vector embedding. The addition operation may be elementwise addition. The positional encoding layer may output an embedding matrix that includes the vector embeddings computed in the positional encoding layer.

An MHA layer (e.g., the MHA layer 241, the MHA layer 251, or the MHA layer 253) may implement a multi-head attention mechanism, which may be a multi-head self-attention mechanism or a multi-head cross-attention mechanism. In some embodiments, the MHA layer 241 or the MHA layer 251 may implement a self-attention mechanism. For self-attention, the queries, keys, and values may come from the same place. For instance, for the MHA layer 241, the queries, keys, and values may all come from the positional encoding layer 215. For the MHA layer 251, the queries, keys, and values may all come from the positional encoding layer 225. The self-attention mechanism may enable the transformer model 200 to relate each token with other tokens. The MHA layer may compute attention scores from embeddings generated in the corresponding positional encoding layer. In some embodiments, the MHA layer may receive one or more queries, one or more keys, and one or more values. In some embodiments, the MHA layer has a number of heads that receive different linearly projected versions of the queries, keys, and values and produce outputs in parallel that are then used to generate the final result.

In some embodiments, the queries, keys, and values input into the MHA layer 241 may be computed from vector embeddings generated by the positional encoding layer 215. The queries, keys, and values input into the MHA layer 251 may be computed from vector embeddings generated by the positional encoding layer 225. A query, key, or value may be a vector the represents a token in a sequence. In some embodiments, a query matrix Q∈ [symbol] ^{N×h} may be computed by multiply an embedding matrix X∈ [symbol] ^{N×d} (e.g., an embedding matrix computed in a positional encoding layer) with a weight matrix W_{q}∈ [symbol] ^{d×h}, where d is the dimension of a vector embedding, N is the number of vector embeddings in the embedding matrix, and h is the number of attention heads. Each row in the query matrix may be a query. A key matrix K∈ [symbol] ^{N×h} may be computed by multiple an embedding matrix X∈ [symbol] ^{N×d} (e.g., an embedding matrix computed in a positional encoding layer) with a weight matrix Wₖ∈ [symbol] ^{d×h}. Each row in the key matrix may be a key. A value matrix V∈ [symbol] ^{N×h} may be computed by multiple an embedding matrix X∈ [symbol] ^{N×d} (e.g., an embedding matrix computed in a positional encoding layer) with a weight matrix Wᵥ∈ [symbol] ^{d×h}. Each row in the value matrix may be a value.

In some embodiments, the MHA layer 251 may implement masked multi-head self-attention. The MHA layer 251 may prevent positions from attending to subsequent positions. For instance, each token in the sequence may not be influenced by future tokens. This masking can ensure that the predictions of a particular position can depend on known outputs at positions before it and not depend on unknown outputs at positions after it.

In some embodiments, the MHA layer 253 may implement a cross-attention mechanism, such as encoder-decoder cross-attention. The MHA layer 253 may use outputs from the previous layer (i.e., the add & norm layer 252) as queries and use outputs from the encoder block 210 as keys and values. The cross-attention can align the encoder's input with the decoder's, empowering the decoder block 220 to identify and emphasize the most relevant parts of the encoder's input.

In some embodiments, an MHA layer includes linear layers, a MatMul layer, a scale layer, a SoftMax layer, another MatMul layer, a concatenation layer, and another linear layer. These layers may be arranged in a sequence. The MHA layer may receive three input matrices: a query matrix, a key matrix, and a value matrix, which are inputs of three linear layers, respectively. The linear layers may include matrix multiplication (MatMul) operations. For instance, a first linear layer may perform a multiplication of the query matrix with a weight matrix to compute a first parameter matrix. The first parameter matrix may be denoted as

$$Q {W}_{i}^{Q} ,$$

where Q is the query matrix and

$${W}_{i}^{Q}$$

∈ [symbol] ^{d}^{_{model}}^{×d}^{_{q}} is the weight matrix. A second linear layer may perform a multiplication of the key matrix with a weight matrix to compute a second parameter matrix. The second parameter matrix may be denoted as

$$K {W}_{i}^{K} ,$$

where K is the key matrix and

$${W}_{i}^{K}$$

∈ [symbol] ^{d}^{_{model}}^{×d}^{ₖ} is the weight matrix. A third linear layer may perform a multiplication of the value matrix with a weight matrix to compute a third parameter matrix. The third parameter matrix may be denoted as

$$V {W}_{i}^{V} ,$$

where V is the value matrix and

$${W}_{i}^{V}$$

∈ [symbol] ^{d}^{_{model}}^{×d}^{ₖ} is the weight matrix. i may indicate the index of the head. d_{q} is the dimension of a query vector. dₖ is the dimension of a key vector. dᵥ is the dimension of a value vector. In some embodiments, d_{q}=dₖ=dᵥ=d_{model}/h. In some embodiments, the linear layers may be in a linear block of the MHA layer. In some embodiments, the MHA layer may include multiple linear blocks. For instance, the MHA layer includes h linear blocks. The linear blocks may have the same layers as each other. Each linear block may compute three parameter matrices from the query matrix, key matrix, and value matrix, respectively.

The MatMul layer, scale layer, mask layer, SoftMax layer, and MatMul layer may be in an attention block of the MHA layer. The attention block may implement a scaled dot-product attention mechanism. In some embodiments, the MHA layer includes a plurality of attention blocks that includes the attention block. For the purpose of illustration, the MHA layer includes h attention blocks. The attention blocks may have the same layers as each other. A linear block and an attention block may constitute a head of the MHA layer. When the MHA layer has h linear blocks and h attention blocks, the MHA layer has h heads. A head may be denoted as

$${head}_{i} = Attention ( {QW}_{i}^{Q} , {KW}_{i}^{K} , {VW}_{i}^{V} ) .$$

A matrix multiplication operation may be performed on parameter matrices in the MatMul layer, which computes a score matrix. In some embodiments, the score matrix may establish the degree of emphasis each token should place on other tokens. The score matrix may include a plurality of scores. Each token may be assigned a score in relation to other tokens within the same time step. A higher score may indicate a higher focus or emphasis. The score matrix may be scaled in the scale layer. In some embodiments, the score matrix is scaled down in the scale layer by dividing the scores in the score matrix by the square root of the dimension of the query vector and the key vector, which may be denoted as \sqrt{dₖ}. The output of the scale layer may be a scaled matrix, which includes adjusted scores. The mask layer may be optional in some embodiments. The mask layer may add an attention mask (which may be an input to the attention block) to the output of the scale layer to mask out some elements in the output of the scale layer. The positions of the masked-out elements may be defined by the attention mask. A Softmax function may be applied on the scaled matrix in the Softmax layer to compute an attention weight matrix. The attention weight matrix includes attention weights. The attention weights may be probability values ranging from 0 to 1. The SoftMax function may emphasize high scores while diminishing low scores, which can enhance the model's ability to determine which tokens should get more attention.

In the MatMul layer, a matrix multiplication operation is performed on the attention weight matrix computed in the SoftMax layer and the parameter matrix computed from value matrix in the corresponding linear layer. The result of the matrix multiplication operation is a single-head output matrix, which is an output of the attention block.

When the MHA layer has h attention blocks, there may be h single-head output matrices. The single-head output matrices are concatenated in the concatenation layer to form a concatenated matrix. A linear operation (also referred to as “linear transformation”) is performed on the concatenated matrix using a weight matrix in the linear layer. In some embodiments, the MHA may be denoted as MultiHead(Q, K, V)=Concat(head₁, head₂, . . . , headₕ)W^{O}, where Concat denotes concatenation, and W^{O}∈ [symbol] ^{hd}^{ᵥ}^{×d}^{_{model}} is the weight matrix in the corresponding linear layer.

An add & norm layer in the transformer model 200, such as the add & norm layer 242, 244, 252, 254, and 256, has an addition operation followed by a layer normalization operation. The addition operation may be an addition of the output of the preceding layer and the input of the preceding layer. The preceding layer is a layer that is arranged right before the add & norm layer. For example, the preceding layer of the add & norm layer 242 is the MHA layer 241. As another example, the preceding layer of the add & norm layer 254 is the MHA layer 253.

Then the layer normalization operation is applied on the result of the addition operation, which may be denoted as LayerNorm(x+sublayer(x)), where LayerNorm denotes layer normalization, x is the input of the preceding layer, and sublayer (x) denotes the output of the preceding layer. In some embodiments, the layer normalization operation may include a sequence of computations. In an example, the layer normalization operation may include a mean computation, which may be denoted as

$${μ}_{x y} = \frac{1}{Z} \times {\sum }_{z = 1}^{Z} {A}_{xyz} ,$$

where A_{xyz} denotes a data element in the input tensor, x may be the positional index of the data element in one of the spatial dimensions, y may be the positional index of the data element in the other one of the spatial dimensions, z may be the positional index of the data element in the channel dimension, and μ_{xy} denotes the output of the mean computation, which may be a 2D matrix. The mean computation may be channel-wise reduction operation. The layer normalization operation may convert μ_{xy} to a 3D tensor μ_{xyz}, e.g., by replicating every data element over z output points.

The layer normalization operation may also include an elementwise subtraction, which may be denoted as D_{xyz}=A_{xyz}−μ_{xyz}. The layer normalization operation may further include a variance computation denoted as

$${σ}_{x y}^{2} = {\sum }_{z = 1}^{Z} {D}_{x y z}^{2}$$

and a division computation denoted as

$${M}_{x y} = \frac{1}{\sqrt{\frac{1}{Z} \times ( {σ}_{x y}^{2} + ϵ \times Z )}} .$$

M_{xy} may be a 2D tensor. The layer normalization operation my also convert M_{xy} to a 3D tensor M_{xyz}, e.g., by replicating every data element over z output points. Further, the layer normalization operation may have an element multiplication denoted as

$${A}_{x y z}^{′} = \frac{{A}_{x y z} - {μ}_{x y z}}{\sqrt{\frac{1}{Z} \times ( {σ}_{x y}^{2} + ϵ )}} = ( {A}_{x y z} - {μ}_{x y z} ) \times \frac{1}{\sqrt{\frac{1}{Z} \times ( {σ}_{x y}^{2} + ϵ )}} = {D}_{x y z} \times {M}_{x y z} .$$

The layer normalization operation may further compute

$${A}_{x y z}^{″} = {A}_{x y z}^{′} + \frac{{β}_{z}}{{γ}_{z}} and L {N}_{x y z} = {A}_{x y z}^{″} \times {γ}_{z} . L {N}_{x y z}$$

may be the output of the layer normalization operation.

A feed forward layer (e.g., the feed forward layer 243 and the feed forward layer 255) may be a position-wise fully-connected feed forward network. In an example, the feed forward layer may include two linear layers with an activation function in between. An example of the activation function is Rectified Linear Unit (ReLU).

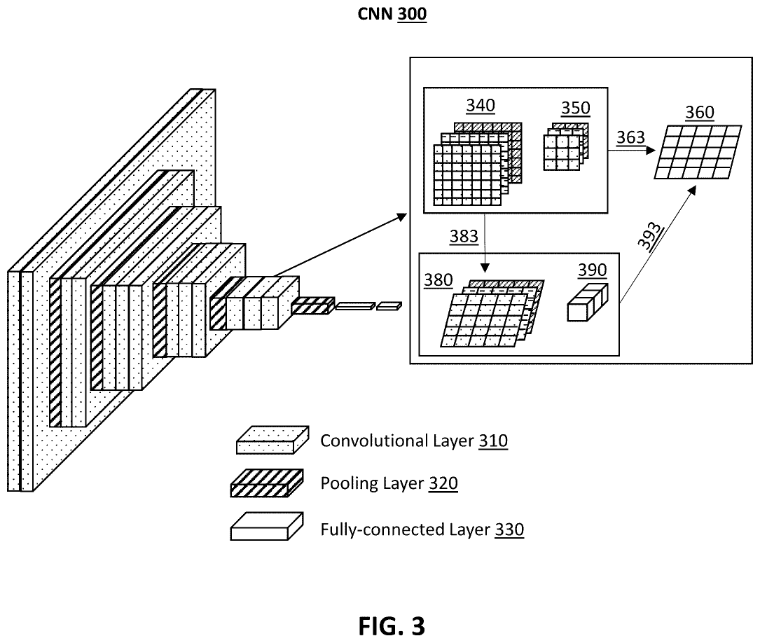

FIG. 3 illustrates an example CNN 300, in accordance with various embodiments. The CNN 300 may be trained or deployed by the AI system 100 in FIG. 1. The CNN 300 may be an example of the DNNs described herein. The CNN 300 may be trained by the training module 140 in FIG. 1. For the purpose of illustration, the CNN 300 includes a sequence of layers comprising a plurality of convolutional layers 310 (individually referred to as “convolutional layer 310”), a plurality of pooling layers 320 (individually referred to as “pooling layer 320”), and a plurality of fully-connected layers 330 (individually referred to as “fully-connected layer 330”). In other embodiments, the CNN 300 may include fewer, more, or different layers. In an execution of the CNN 300, the layers of the CNN 300 execute tensor computation that includes many tensor operations, such as convolutions, interpolations, pooling operations, elementwise operations (e.g., elementwise addition, elementwise multiplication, etc.), other types of tensor operations, or some combination thereof.

The convolutional layers 310 summarize the presence of features in inputs to the CNN 300. The convolutional layers 310 function as feature extractors. The first layer of the CNN 300 is a convolutional layer 310. In an example, a convolutional layer 310 performs a convolution on an input tensor 340 (also referred to as IFM 340) and a filter 350. As shown in FIG. 3, the IFM 340 is represented by a 7×7×3 three-dimensional (3D) matrix. The IFM 340 includes 3 input channels, each of which is represented by a 7×7 two-dimensional (2D) matrix. The 7×7 2D matrix includes 7 input elements (also referred to as input points) in each row and 7 input elements in each column. The filter 350 is represented by a 3×3×3 3D matrix. The filter 350 includes 3 kernels, each of which may correspond to a different input channel of the IFM 340. A kernel is a 2D matrix of weights, where the weights are arranged in columns and rows. A kernel can be smaller than the IFM. In the embodiments of FIG. 3, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 350 in extracting features from the IFM 340.

The convolution includes multiply-accumulate (MAC) operations with the input elements in the IFM 340 and the weights in the filter 350. The convolution may be a standard convolution 363 or a depthwise convolution 383. In the standard convolution 363, the whole filter 350 slides across the IFM 340. All the input channels are combined to produce an output tensor 360 (also referred to as output feature map (OFM) 360). The OFM 360 is represented by a 5×5 2D matrix. The 5×5 2D matrix includes 5 output elements (also referred to as output points) in each row and 5 output elements in each column. For the purpose of illustration, the standard convolution includes one filter in the embodiments of FIG. 3. In embodiments where there are multiple filters, the standard convolution may produce multiple OCs in the OFM 360.

The multiplication applied between a kernel-sized patch of the IFM 340 and a kernel may be a dot product. A dot product is the elementwise multiplication between the kernel-sized patch of the IFM 340 and the corresponding kernel, which is then summed, always resulting in a single value. Because it results in a single value, the operation is often referred to as the “scalar product.” Using a kernel smaller than the IFM 340 is intentional as it allows the same kernel (set of weights) to be multiplied by the IFM 340 multiple times at different points on the IFM 340. Specifically, the kernel is applied systematically to each overlapping part or kernel-sized patch of the IFM 340, left to right, top to bottom. The result from multiplying the kernel with the IFM 340 one time is a single value. As the kernel is applied multiple times to the IFM 340, the multiplication result is a 2D matrix of output elements. As such, the 2D output matrix (i.e., the OFM 360) from the standard convolution 363 is referred to as an OFM.

In the depthwise convolution 383, the input channels are not combined. Rather, MAC operations are performed on an individual input channel and an individual kernel and produce an OC. As shown in FIG. 3, the depthwise convolution 383 produces a depthwise output tensor 380. The depthwise output tensor 380 is represented by a 5×5×3 3D matrix. The depthwise output tensor 380 includes 3 OCs, each of which is represented by a 5×5 2D matrix. The 5×5 2D matrix includes 5 output elements in each row and 5 output elements in each column. Each OC is a result of MAC operations of an input channel of the IFM 340 and a kernel of the filter 350. For instance, the first OC (patterned with dots) is a result of MAC operations of the first input channel (patterned with dots) and the first kernel (patterned with dots), the second OC (patterned with horizontal strips) is a result of MAC operations of the second input channel (patterned with horizontal strips) and the second kernel (patterned with horizontal strips), and the third OC (patterned with diagonal stripes) is a result of MAC operations of the third input channel (patterned with diagonal stripes) and the third kernel (patterned with diagonal stripes). In such a depthwise convolution, the number of input channels equals the number of OCs, and each OC corresponds to a different input channel. The input channels and output channels are referred to collectively as depthwise channels. After the depthwise convolution, a pointwise convolution 393 is then performed on the depthwise output tensor 380 and a 3×1×3 tensor 390 to produce the OFM 360.

The OFM 360 is then passed to the next layer in the sequence. In some embodiments, the OFM 360 is passed through an activation function. An example activation function is rectified linear unit (ReLU). ReLU is a calculation that returns the value provided as input directly, or the value zero if the input is zero or less. The convolutional layer 310 may receive several images as input and calculate the convolution of each of them with each of the kernels. This process can be repeated several times. For instance, the OFM 360 is passed to the subsequent convolutional layer 310 (i.e., the convolutional layer 310 following the convolutional layer 310 generating the OFM 360 in the sequence). The subsequent convolutional layers 310 perform a convolution on the OFM 360 with new kernels and generate a new feature map. The new feature map may also be normalized and resized. The new feature map can be kernelled again by a further subsequent convolutional layer 310, and so on.

In some embodiments, a convolutional layer 310 has four hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 310). The convolutional layers 310 may perform various types of convolutions, such as 2-dimensional convolution, dilated or atrous convolution, spatial separable convolution, depthwise separable convolution, transposed convolution, and so on. The CNN 300 includes 36 convolutional layers 310. In other embodiments, the CNN 300 may include a different number of convolutional layers.

The pooling layers 320 down-sample feature maps generated by the convolutional layers, e.g., by summarizing the presence of features in the patches of the feature maps. A pooling layer 320 is placed between two convolution layers 310: a preceding convolutional layer 310 (the convolution layer 310 preceding the pooling layer 320 in the sequence of layers) and a subsequent convolutional layer 310 (the convolution layer 310 subsequent to the pooling layer 320 in the sequence of layers). In some embodiments, a pooling layer 320 is added after a convolutional layer 310, e.g., after an activation function (e.g., ReLU, etc.) has been applied to the OFM 360.

A pooling layer 320 receives feature maps generated by the preceding convolution layer 310 and applies a pooling operation to the feature maps. The pooling operation reduces the size of the feature maps while preserving their important characteristics. Accordingly, the pooling operation improves the efficiency of the DNN and avoids over-learning. The pooling layers 320 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 320 applied to a feature map of 6×6 results in an output pooled feature map of 3×3. The output of the pooling layer 320 is input into the subsequent convolution layer 310 for further feature extraction. In some embodiments, the pooling layer 320 operates upon each feature map separately to create a new set of the same number of pooled feature maps.

The fully-connected layers 330 are the last layers of the DNN. The fully-connected layers 330 may be convolutional or not. The fully-connected layers 330 receive an input operand. The input operand defines the output of the convolutional layers 310 and pooling layers 320 and includes the values of the last feature map generated by the last pooling layer 320 in the sequence. The fully-connected layers 330 apply a linear combination and an activation function to the input operand and generate a vector. The vector may contain as many elements as there are classes: element i represents the probability that the image belongs to class i. Each element is therefore between 0 and 3, and the sum of all is worth one. These probabilities are calculated by the last fully-connected layer 330 by using a logistic function (binary classification) or a SoftMax function (multi-class classification) as an activation function. In some embodiments, the fully-connected layers 330 multiply each input element by weight, make the sum, and then apply an activation function (e.g., logistic if N=2, SoftMax if N>2). This is equivalent to multiplying the input operand by the matrix containing the weights.

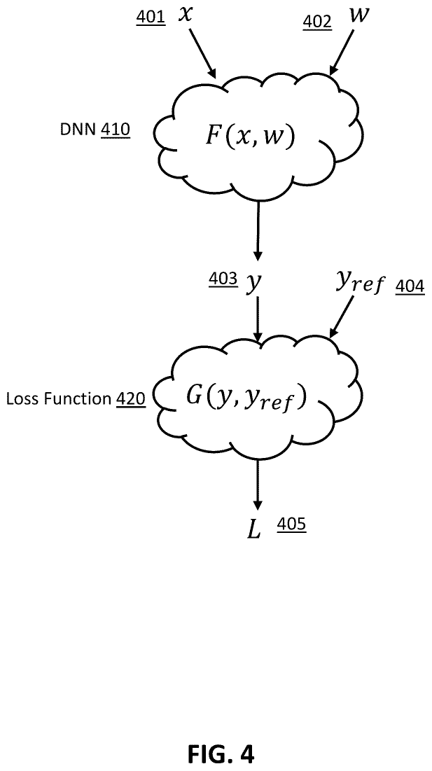

FIG. 4 illustrates operations in a forward pass of a DNN training process, in accordance with various embodiments. The training process is for training a DNN 410. The forward pass may be a process of executing the DNN 410 to predict an output for a given input and measuring the difference between the DNN's prediction and an accurate prediction. The accurate prediction may be a ground truth. In the embodiments of FIG. 4, the forward pass includes an execution of the DNN 410 and an execution of a loss function 420.

The execution of the DNN 410 may include execution of MatMul operations. The DNN 410 receives an input 401 and has an internal parameter set 402. The internal parameter set 402 includes the learnable parameters in the DNN 410. The execution of the DNN 410 is denoted as y=F(x, w) in FIG. 4, where F denotes the architecture of the DNN 410 (e.g., parametrizable functions in the DNN 410), x denotes the input 401, w denotes the internal parameter set 402, and y denotes an output 403 predicted by the DNN 410.

The output 403 and a reference prediction 404 are input into the loss function 420. The reference prediction 404 may be a prediction that has been verified to be true or accurate. In some embodiments, the reference prediction 404 includes one or more reference values representing a ground-truth label of the input 401. The input 401 and reference prediction 404 may be in a training dataset used for the training process. The execution of the loss function 420 is denoted as L=G (y, y_{ref}) in FIG. 4, where G denotes the loss function 420, y_{ref} denotes the reference prediction 404, and L denotes a loss 405. The loss 405 indicates the difference between the output 403 of the DNN 410 and the reference prediction 404.

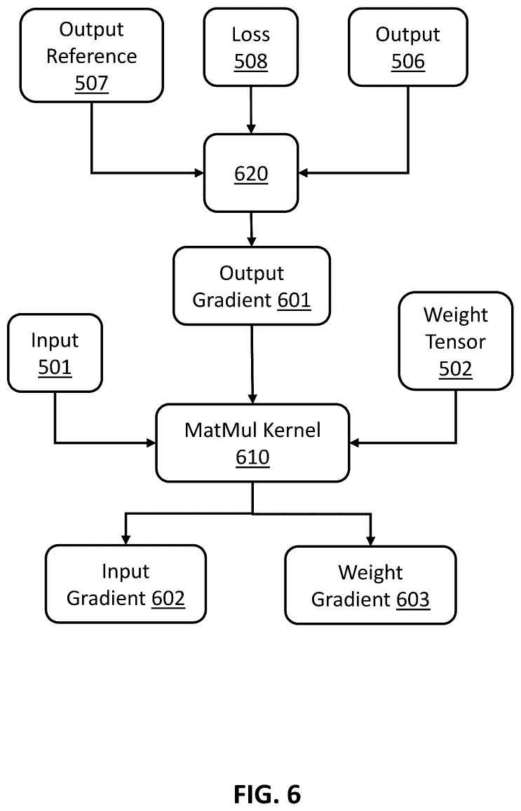

In some embodiments, the forward pass may be denoted as:

$$L = \frac{1}{N} \sum G ( F ( x , w ) , {y}_{r e f} ) ,$$

where N may be the number of training samples in a batch. The loss L may be used for a single update of one or more internal parameters of the DNN. After the forward pass, a backward pass may be performed, in which gradients are computed and the internal parameter set 402 may be updated based on the gradients to minimize the loss 405. The training process may include multiple forward passes and multiple backward passes. Certain aspects about backward pass are described below in conjunction with FIG. 6.

FIG. 5 illustrates a forward pass offloaded to a MatMul kernel 510 and LoRA kernels 520A and 520B of a NPU, in accordance with various embodiments. The forward pass may be a forward pass of a LoRA fine-tuning process. An example of the NPU is the NPU 120B in FIG. 1. The MatMul kernel 510, LoRA kernel 520A, or LoRA kernel 520B may include a processing engine in the NPU. For instance, the MatMul kernel 510, LoRA kernel 520A, or LoRA kernel 520B may include an MAC array or computer-in-memory array. In some embodiments, the MatMul kernel 510, LoRA kernel 520A, and LoRA kernel 520B may be implemented on a single processing engine of the NPU. In other embodiments, the MatMul kernel 510, LoRA kernel 520A, and LoRA kernel 520B may be implemented on multiple processing engines of the NPU, which may operate in parallel.

As shown in FIG. 5, the MatMul kernel 510 receives an input 501 and weight tensor 502. The input 501 may be a training sample, such as an input image, input token sequence etc. The MatMul kernel 510 may execute the MatMul operator, a result of which is a tensor 503. The LoRA kernel 520A receives the input 501 and a low-rank weight tensor 502A. The LoRA kernel 520A may execute an MatMul operator on the input 501 and low-rank weight tensor 502A and compute an intermediate tensor 504. The LoRA kernel 520B receives the intermediate tensor 504 and a low-rank weight tensor 502B. The LoRA kernel 520B may execute an MatMul operator on the intermediate tensor 504 and low-rank weight tensor 502B and compute a tensor 505.

The forward pass also involves an add kernel 550 of the NPU. In the illustrated example, the add kernel 550 receives the tensor 503 and tensor 505. The add kernel 550 may execute an elementwise addition operator on the tensor 503 and tensor 505 and compute an output 506. The NPU also has a loss function kernel 530. The output 506 and an output reference 507 are provided to the loss function kernel 530. The loss function kernel 530 may apply a loss function to the output 506 and output reference 507 to compute a loss 508. The loss function kernel 530 may be the same or similar as the loss function kernel 520 in FIG. 5. The loss 508 may be used to update the low-rank weight tensor 502A and low-rank weight tensor 502B, e.g., during a backward pass of the LoRA fine-tuning process. The weight tensor 502 may remain the same during the LoRA fine-tuning process.

In some embodiments, the MatMul kernel 510, LoRA kernel 520A, or LoRA kernel 520B may include one or more computing components in the NPU. For instance, the MatMul kernel 510, LoRA kernel 520A, or LoRA kernel 520B may be a processing engine in the NPU. The MatMul kernel 510, LoRA kernel 520A, or LoRA kernel 520B may have been designed to adapt to tensors of various dimensions. In some embodiments, the LoRA kernel 520A and LoRA kernel 520B may be combined into a single differentiable kernel.

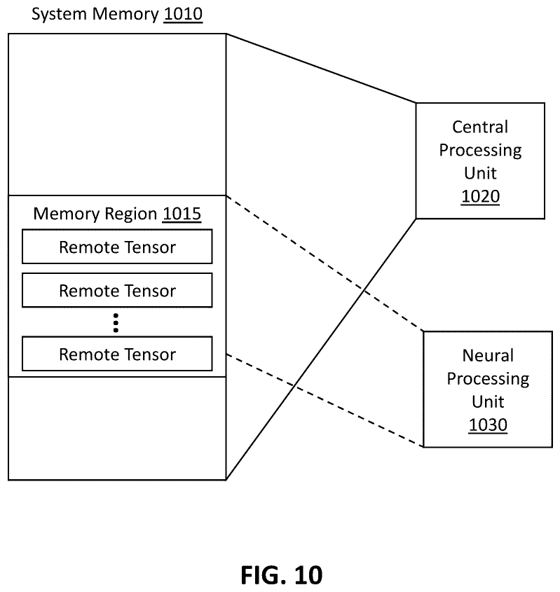

In some embodiments, the input 501, weight tensor 502, low-rank weight tensor 502A, low-rank weight tensor 502B, tensor 503, intermediate tensor 504, tensor 505, or output 506 may be stored in a remote memory that is not local to the NPU. A DMA engine coupled with the NPU may read the input 501 and weight tensor 502 from the remote memory and transfer them to the MatMul kernel 510. The DMA engine may also transfer the input 501 and low-rank weight tensor 502A from the remote memory to the LoRA kernel 520A. The DMA engine may also transfer the intermediate tensor 504 and low-rank weight tensor 502B from the remote memory to the LoRA kernel 520B. The DMA engine may further transfer the output 506 from the remote memory to the loss function kernel 530. The DMA engine may also write the intermediate tensor 504, output 506, or loss 508 from the NPU into the remote memory. Certain aspects regarding remote memory are described below in conjunction with FIG. 10. In some embodiments, the output 506 or loss 508 may be stored in a memory that is local to the NPU for further computation, e.g., computations in the backward pass.

The forward pass in FIG. 5 may provide a mixed Graph-Eager mode. The path through the MatMul kernel 510 may be a graph path, and the path through the LoRA kernel 520A and LoRA kernel 520B may be an eager path. The graph path may be much bigger as the weight tensor 502 may have a much higher rank than the low-rank weight tensor 502A and low-rank weight tensor 502B. The graph path may dominate the inference time. A backward pass may be performed after the forward pass. The low-rank weight tensor 502A or low-rank weight tensor 502B may be updated during the backward pass, while the weight tensor 502 may remain the same during the backward pass.

In some embodiments, the differentiable LoRA-specific computational kernels are optimized for mixed Graph-Eager execution modes on NPU architectures. These kernels can provide fine-grained control over parameter updates while maintaining computational efficiency through selective freezing of base model weights. The base model parameters may remain static and read-only in NPU memory, while LoRA adaptation matrices can be allocated in writable memory regions, enabling efficient gradient computation without the overhead of full model backpropagation.

FIG. 6 illustrates a backward pass on NPU, in accordance with various embodiments. The backward pass may be performed after the forward pass in FIG. 5. In the embodiments of FIG. 6, the backward pass is offloaded to a MatMul kernel 610 of the NPU. In some embodiments, the MatMul kernel 610 may be a combination of the MatMul kernel 510, LoRA kernel 520A, and LoRA kernel 520B in FIG. 5. For instance, the MatMul kernel 510, LoRA kernel 520A, and LoRA kernel 520B may be differentiable kernels on the NPU that can perform operations in both the forward pass and backward pass. In other embodiments, the MatMul kernel 610 may be another kernel that coexists with the MatMul kernel 510, LoRA kernel 520A, and LoRA kernel 520B on the same NPU. The backward pass in FIG. 6 is performed by the MatMul kernel 610 and an automatic differentiation module 620. The automatic differentiation module 620 may also use the NPU. Alternatively, the automatic differentiation module 620 may use a CPU, such as the CPU 120A in FIG. 1.

As shown in FIG. 6, the output 506, output reference 507, and loss 508 are provided to the automatic differentiation module 620. The automatic differentiation module 620 automatically computes an output gradient 601. The output gradient 601 may be a gradient with respect to the layer output. The output gradient 601 together with the input 501 and weight tensor 502 are provided to the MatMul kernel 610 to compute an input gradient 602 and a weight gradient 603. The input gradient 602 may be a gradient with respect to the layer input. In some embodiments, the MatMul kernel 610 may perform a MatMul operation on the weight tensor 502 and output gradient 601 to compute the input gradient 602. This MatMul operation my be denoted as

$$\frac{\partial L}{\partial x} = \frac{\partial L}{\partial y} * \frac{\partial y}{\partial x} , where \frac{\partial L}{\partial x}$$

denotes the input gradient 602,

$$\frac{\partial L}{\partial y}$$

denotes the output gradient 601, and

$$\frac{\partial y}{\partial x}$$

denotes the weight tensor 502. The input gradient 602 may be passed down to the previous layer, so this is a backpropagation.

The weight gradient 603 may include a gradient of the low-rank weight tensor 502A and a gradient of the low-rank weight tensor 502B with respect to the layer output. In some embodiments, the MatMul kernel 610 may perform a MatMul operation on the input 501 and output gradient 601 to compute the weight gradient 603. This MatMul operation may be denoted as

$$\frac{\partial L}{\partial {W}_{i}} = \frac{\partial L}{\partial y} * \frac{\partial y}{\partial {W}_{i}} ,$$

where Wᵢ denotes the weight tensor of layer i (e.g., the (i+1)-th layer in the DNN),

$$\frac{\partial L}{\partial {W}_{i}}$$

denotes the weight gradient 603 for layer i,

$$\frac{\partial L}{\partial y}$$

denotes the output gradient 601, and

$$\frac{\partial y}{\partial {W}_{i}}$$

denotes the input 501.

$$\frac{\partial L}{\partial {W}_{i}}$$

may be the gradient of the loss function with respect to Wᵢ. In some embodiments,

$$\frac{\partial L}{\partial {W}_{i}}$$

may be a tensor having the same spatial shape as Wᵢ.

During the backward pass, the input may be the gradient with respect to the layer output. The input gradient and weight gradient may be computed for each layer by performing the two MatMul operations described above. The input gradients may be passed backward through the layers of the DNN. An optimization process may be performed based on weight gradients to update the weights in the DNN. In some embodiments, the low-rank weight tensor 502A or low-rank weight tensor 502B may be updated during the optimization process, while the weight tensor 502 may remain the same. The weight update using gradient descent may be denoted as

$${W}_{i}^{N + 1} = {W}_{i}^{N} - γ {∇}_{{W}_{i}} L ,$$

where N denotes an optimization step, and N+1 denotes the next optimization step.

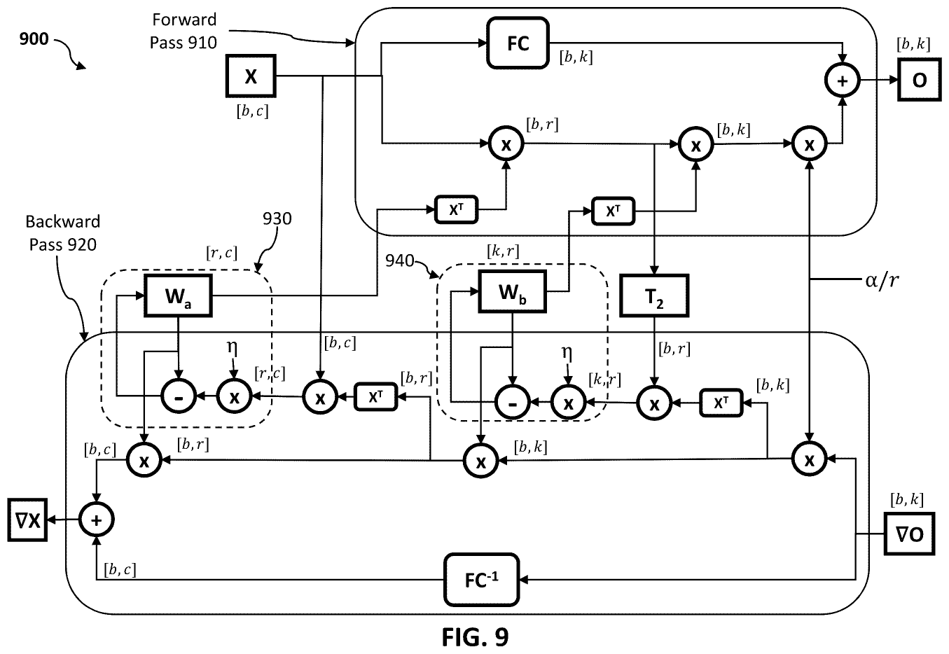

During training, weights are model inputs so can be updated during training. weights are not fixed and may be changed after every optimization step. Recompilation of the full model for every optimization step can be a massive overhead. The training framework usually keeps track of gradients. In the backward pass, the network outputs may be gradients with respect to the network inputs and gradients as described above. The backward pass may be a directed acyclic graph (DAG). DAG may be a graph structure used to model the sequence of operations in DNN training, ensuring efficient computation of gradients without cycles. However, currently available training frameworks mostly focus on inference. Some operators (e.g., LayerNorm, dropout, etc.) may have specific backward runtime. Some gradients are nonlinear and require control flow. The differentiable LoRA-NPU kernels (e.g., the LoRA kernel 520A and LoRA kernel 520B) that can address these challenges. Original weights (e.g., the weight tensor 502) are frozen and can be put in the model for better performance. Certain aspects regarding LoRA weight update are described below in conjunction with FIG. 9.

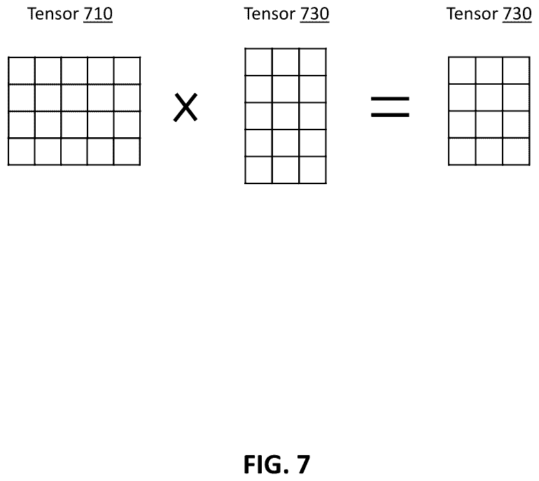

FIG. 7 illustrates a MatMul operation, in accordance with various embodiments. The MatMul operation is performed on a tensor 710 and tensor 720 and produces a tensor 730. In some embodiments, the MatMul operation may be an operation in a DNN layer. The tensor 710 may be generated at the previous layer, and the tensor 720 may include internal parameters of the DNN layer. The tensor 730 may be an output or intermediate tensor of the DNN layer. The DNN layer may be a convolutional layer, a multi-head attention (MHA) layer, or other types of layers. The MatMul operation may be performed in a forward pass of a DNN training process. In other embodiments, the MatMul operation may be performed in a backward pass of a DNN training process. The MatMul operation may be performed to compute gradients. For instance, the tensor 730 may be a tensor of input gradients with respect to a loss function or a tensor of weight gradients with respect to a loss function.

For illustration, the tensor 710 and tensor 720 are 2D tensors. The spatial size of the tensor 710 is 1×4×5. The spatial size of the tensor 720 is 1×5×3. In some embodiments, a dot product is performed between each row of the tensor 710 and each column of the tensor 720 to generate a single point in the tensor 730. The spatial size of the tensor 730 is 1×4×3. In other embodiments, the tensor 710, tensor 720, or tensor 730 may have a different shape. The tensor 710, tensor 720, or tensor 730 be a 3D tensor.

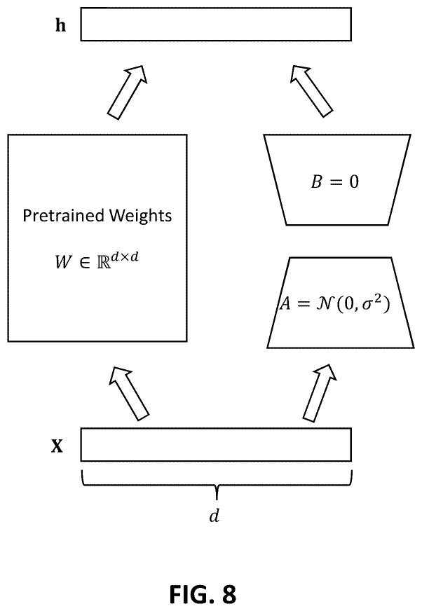

FIG. 8 illustrates a DNN layer with low-rank adapters, in accordance with various embodiments. The DNN layer may be a layer of a pretrained DNN. Examples of the DNN layer may include attention layer, feed forward layer, fully-connected layer, and so on. The DNN layer has a weight tensor W∈ [symbol] ^{d×d}. The weight tensor may have been determined through the training process. For fine-tuning the pretrained DNN layer, low-rank adapters A and B are introduced into the DNN layer. The low-rank adapters A and B may have smaller weight tensors than the original weight tensor W. During fine-tuning, instead of updating the large number of weights in the weight tensor W, LoRA may update the low-rank adapters A and B. The number of trainable parameters can be significantly reduced compared to full fine tuning. After fine-tuning, the low-rank adapters A and B may be merged with the original weight tensor W to update the DNN layer. The updated DNN layer may be used for deployment.

FIG. 9 illustrates a LoRA fine-tuning process 900 on an NPU, in accordance with various embodiments. The NPU may be the NPU 120B in FIG. 1. As shown in FIG. 9, the LoRA fine-tuning process 900 includes a forward pass 910 and backward pass 920.

The forward pass 910 may start with an input (X). The input may be a tensor with shape [b, c], where b is the batch size and c is the input feature size. In some embodiments, the input feature size indicates the number of input channels of frozen layer. The input is processed in a frozen layer (FC). In some embodiments, the frozen layer is a DNN layer (e.g., a fully-connected layer) whose internal parameters (e.g., weights) are frozen so that the weights remain the same during the LoRA fine-tuning process 900. The frozen layer may compute an output FC(X) from the input using the frozen weights. The output may be a tensor with shape [b, k], where b is the batch size and k is the output feature size. In some embodiments, the output feature size indicates the number of output channels of frozen layer.

The forward pass 910 also has a LoRA path. The LoRA path involves a transpose operator that transposes a low-rank tensor Wₐ and another transpose operator that transposes on a another low-rank tensor W_{b}. The transpose operators are represented by x^{T} in FIG. 9. A transpose operator may flip a matrix over its diagonal to switch the row and column indices of the matrix to produce another matrix. The first transpose operation produces a transpose of the low-rank tensor Wₐ, which is denoted as

$${w}_{a}^{T} .$$

An MatMul operator may be applied on

$${W}_{a}^{T}$$

and the input, resulting in an intermediate tensor

$$( X \cdot {W}_{a}^{T} ) .$$

The intermediate tensor

$$( X \cdot {W}_{a}^{T} )$$

may project the input into a low-rank space ([b, r]). The shape of the intermediate tensor

$$( X \cdot {W}_{a}^{T} )$$

is [b, r], where b is the batch size and r is the LoRA rank. In some embodiments, r<<min(d, k). The rank r may control adapter size and capacity. It may be a hyperparameter and may be determined by the training module 140 in FIG. 1 or a user.

The second transpose operation produces a transpose of the low-rank tensor W_{b}, which is denoted as

$${W}_{b}^{T} .$$

An MatMul operator may pe applied on

$${W}_{b}^{T} and X \cdot {W}_{a}^{T}$$

to compute another intermediate tensor

$$( ( X \cdot {W}_{a}^{T} ) \cdot {W}_{b}^{T} ) .$$

The intermediate tensor

$$( ( X \cdot {W}_{a}^{T} ) \cdot {W}_{b}^{T} )$$

may project back to the output space ([b, k]). The shape of the intermediate tensor

$$( ( X \cdot {W}_{a}^{T} ) \cdot {W}_{b}^{T} )$$

is [b, k]. The intermediate tensor

$$( ( X \cdot {W}_{a}^{T} ) \cdot {W}_{b}^{T} )$$

may then be scaled by α/r to compute a scaled contribution of the LoRA path to the output. α may be a scaling factor and may normalize update magnitude. It may be a hyperparameter and may be determined by the training module 140 in FIG. 1 or a user. The final output may be computed by performing an elementwise addition on FC(X) and the scaled intermediate tensor. The final output may pe denoted as

$$O = FC ( X ) + \frac{α}{r} \cdot ( X \cdot {W}_{a}^{T} ) \cdot {W}_{b}^{T} .$$

The addition of the two low-rank tensors may modify the weights of the forward pass 910. The modification may be denoted as W′=W+α(Wₐ·W_{b}), where W is the weight tensor of the frozen layer, α is a LoRA parameter (e.g., LoRA alpha), and W′ is the modified weight tensor. Wₐ or W_{b} may have less weights than W.

The two low-rank tensors Wₐ and W_{b} may be trainable matrices that can be trained through the LoRA fine-tuning process 900. For instance, data elements in the two low-rank tensors Wₐ and W_{b} may be updated during the backward pass 920. The backward pass 920 includes a weight update step 930, in which the low-rank tensor Wₐ may be updated, and a weight update step 940, in which the low-rank tensor W_{b} may be updated. The weight update step 930 and a weight update step 940 may be performed in accordance with a learning rate η. The learning rate η may be a learning hyperparameter that can be predetermined by the training module 140 or predefined by a user. In some embodiments, the learning rate η indicates how much the trainable LoRA adapter weights are adjusted during each optimization step. The learning rate η may control the step size for weight updates during gradient descent. In the backward pass 920, the outputs may be gradients with respect to the input and parameters. The backward pass 920 may start with the output gradient (∇O), which is processed in the inverse of the frozen layer (FC⁻¹). The weights of the frozen layer may not be updated. The backward pass 920 also has a LoRA path, which may be the reverse of the LoRA path in the forward pass 910. The weight update step 930 and weight update step 940 are associated with the LoRA path.

In the LoRA path of the backward pass 920, the output gradient is multiplied by α/r, resulting in

$$\frac{α}{r} \cdot ( ∇ O ) .$$

### Then

$$\frac{α}{r} \cdot ( ∇ O )$$

is multiplied with W_{b} to compute

$$\frac{α}{r} \cdot ( ∇ O ) \cdot {W}_{b} .$$

### Further,

$$\frac{α}{r} \cdot ( ∇ O ) \cdot {W}_{b}$$

is multiplied with Wₐ to compute

$$\frac{α}{r} \cdot ( ∇ O ) \cdot {W}_{b} \cdot {W}_{a} ,$$

which is added to the output of FC⁻¹ to compute the input gradient ∇X.

To update W_{b}, a transpose operator is then performed on

$$\frac{α}{r} \cdot ( ∇ O ) ,$$

and the result of the transpose operator

$$\frac{α}{r} \cdot {( ∇ O )}^{T}$$

is multiplied with T₂. T₂ may be the intermediate tensor

$$( X \cdot {W}_{a}^{T} ) .$$

$${T}_{2} \cdot ( \frac{α}{r} \cdot {( ∇ O )}^{T} )$$

may be the gradient of W_{b}, which is denoted as ∇W_{b}. The weight update step 940 may include weight update W_{b}(N+1)=W_{b}(N)−η*∇W_{b}.

To update Wₐ,

$$\frac{α}{r} \cdot ( ∇ O ) \cdot {W}_{b}$$

is transposed by a transpose operator. The output of the transpose operator may be denoted as

$${( \frac{α}{r} \cdot ( ∇ O ) \cdot {W}_{b} )}^{T} \cdot {( \frac{α}{r} \cdot ( ∇ O ) \cdot {W}_{b} )}^{T}$$

is then multiplied with the input (X) to compute gradient of Wₐ (∇Wₐ). ∇Wₐ may be used to update Wₐ in the weight update step 930. The weight update in the weight update step 930 may be denoted as

$${W}_{a} ( N + 1 ) = {W}_{a} ( N ) - η * ∇ {W}_{a} .$$

After Wₐ and W_{b} are trained, they may be integrated with the pretrained weights of the frozen layer. For instance, a weight folding mechanism may be used to integrate trained LoRA parameters back into the base model structure, creating a unified model representation optimized for inference performance. This folding process can eliminate the computational overhead of separate LoRA layers during inference while preserving all learned adaptations. The integrated model can then be exported using OpenVINO GenAI for highly optimized runtime performance, leveraging inference optimization stack for maximum efficiency.

In some embodiments, tensors used or generated in the LoRA fine-tuning process 900 may be stored in a memory that is remote from the NPU. For instance, the tensors may be stored in a system memory, as opposed to the local memory of the NPU. The tensors may include the input (X), output (O), output gradient (∇O), input gradient (∇X), low-rank tensor (Wₐ), low-rank tensor (W_{b}), intermediate tensor (T₂), other tensors involved in the LoRA fine-tuning process 900, or some combination thereof. Tensors stored in the remote storage may be referred to as remote tensors.

FIG. 10 illustrates remote tensor storage, in accordance with various embodiments. FIG. 10 shows a system memory 1010 coupled with a CPU 1020 and NPU 1030. The CPU 1020 may be an example of the CPU 120A in FIG. 1. The NPU 1030 may be an example of the NPU 120B in FIG. 1.

In the embodiments of FIG. 10, the CPU 1020 may have access to the entire storage region of the system memory 1010. The NPU 1030 may have access to a memory region 1015, which is a part of the system memory 1010. The NPU 1030 may have no access to the rest of the system memory 1010. The system memory 1010 may be a DRAM. Remote tensors for LoRA fine-tuning may be stored in the memory region 1015. A DMA engine may write tensors generated by the NPU 1030 during LoRA fine-tuning into the memory region 1015. The DMA engine may also read remote tensors from the memory region 1015 and transmit the remote tensors to the NPU 1030. For instance, the DMA engine may write the remote tensors into a local memory of the NPU 1030. The local memory may be a SRAM.

The memory architecture can utilize remote tensor allocation directly within NPU memory space, eliminating costly data transfers between system RAM and NPU memory during training iterations. This approach can significantly reduce memory bandwidth requirements and enables larger models to be trained within the constraints of edge device memory hierarchies. The remote tensor management system can provide PyTorch-compatible APIs while optimizing data placement and access patterns for NPU hardware characteristics.

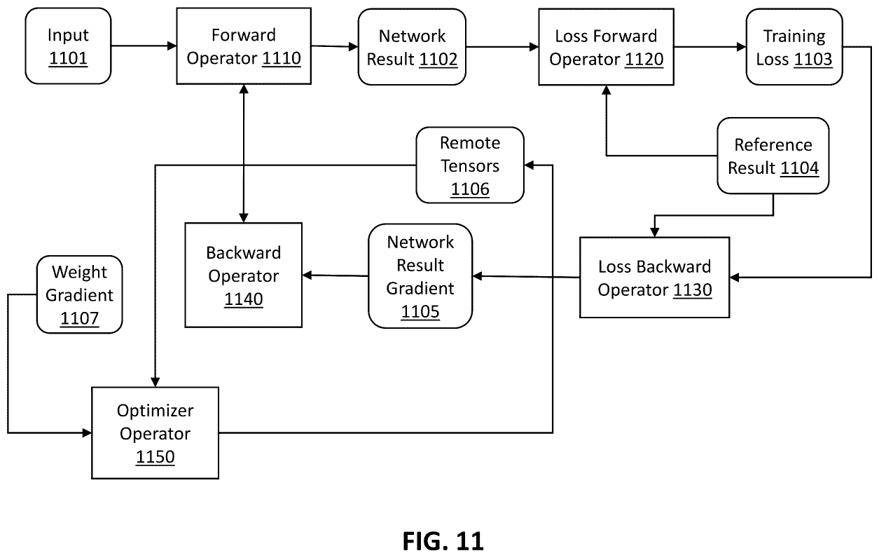

FIG. 11 illustrates a LoRA fine-tuning pipeline, in accordance with various embodiments. The LoRA fine-tuning pipeline may be used for fine-tuning a pretrained DNN model based on low-rank adaptors. The LoRA fine-tuning pipeline involves a plurality of operators, including a forward operator 1110, a loss forward operator 1120, a loss backward operator 1130, a backward operator 1140, and an optimizer operator 1150. In some embodiments, the forward operator 1110, loss forward operator 1120, loss backward operator 1130, backward operator 1140, or optimizer operator 1150 may be a group of sub-operators. For instance, the forward operator 1110 may include one or more MatMul operators, adder operator, and so on. The forward operator 1110, loss forward operator 1120, loss backward operator 1130, backward operator 1140, or optimizer operator 1150 may have an executable file, e.g., a binary file with executable instructions. In an example, the executable file may be an Executable and Linkable Format) (ELF) file. The executable file may be generated by compiling a DNN. In some embodiments, the executable files may be generated by a compiler implemented on a CPU, e.g., the CPU 120A in FIG. 1. After the executable files are generated, they may be provided to an NPU for execution. The NPU may be the NPU 120B in FIG. 1.

As shown in FIG. 11, an input 1101 is provided into the forward operator 1110. The input 1101 may be a training sample. The forward operator 1110 may include one or more operators in the DNN model. For instance, the forward operator 1110 may include operators of one or more layers of the DNN model. The forward operator 1110 outputs a network result 1102. The network result 1102 is provided to the loss forward operator 1120. The loss forward operator 1120 computes a training loss 1103 from the network result 1102 and a reference result 1104. The reference result 1104 may indicate a ground-truth prediction made from the input 1101.

The training loss 1103 is provided to the loss backward operator 1130. The loss backward operator 1130 computes a network result gradient 1105. The network result gradient 1105 may be a network output gradient. The network result gradient 1105 is provided to the backward operator 1140. The backward operator 1140 may have operators, each of which is the reverse of a corresponding operator in the forward operator 1110. The loss backward operator 1130 may also compute remote tensors 1106, which may be stored in a remote memory. The optimizer operator 1150 may use at least part of the remote tensors 1106 and a weight gradient 1107 to update the low-rank adapters. Data computed the optimizer operator 1150 may also be stored in the remote memory as at least part of the remote tensors 1106.

The LoRA fine-tuning pipeline in FIG. 11 may be a complete end-to-end training pipeline that captures forward and backward passes, loss computation, gradient calculation, and weight updates. The LoRA fine-tuning pipeline may use an extended PyTorch framework integrated with a custom compiler toolchain specifically designed to generate NPU-executable code. The system can leverage TorchDynamo for dynamic graph tracing and recompilation, enabling seamless integration with existing PyTorch workflows while providing NPU-specific optimizations. The compiler toolchain may transform high-level training operations into efficient NPU instruction sequences through intermediate representations (e.g., NGraph Lite intermediate representations) and Level Zero API calls.

In some embodiments, fine-tuning operations may be orchestrated through a PyTorch-like API that abstracts the complexity of NPU programming while providing full access to training functionality. Developers can specify LoRA configurations, define training objectives, and manage training loops using familiar PyTorch constructs. The system can automatically handle the compilation of training graphs into NPU-executable formats, manages memory allocation for gradients and intermediate results, and provide debugging and profiling capabilities for training optimization.

The system can support dynamic recompilation capabilities through TorchDynamo integration, enabling adaptation to models with variable input shapes, changing LoRA configurations, or modified training objectives without requiring manual recompilation. This flexibility can be crucial for supporting diverse AI applications with varying computational requirements and adaptation needs.

Hardware-specific optimizations can exploit the unique architectural features of NPUs, including specialized matrix multiplication units, dedicated memory hierarchies, and parallel processing capabilities. The compiler may generate instruction sequences that maximize NPU utilization while minimizing power consumption, enabling sustainable on-device training for battery-powered devices.

The LoRA fine-tuning approach in this disclosure can address critical needs for privacy-preserving AI personalization, real-time model adaptation, and reduced operational costs. By eliminating cloud dependency for model training, the system can protect sensitive user data, reduce latency to near-zero for personalization updates, and eliminate ongoing cloud compute expenses. This capability can enable new categories of AI applications including truly private personal assistants, real-time domain adaptation for professional tools, and personalized content generation that adapt continuously to user preferences without compromising data privacy.

The LoRA fine-tuning approach in this disclosure can accelerate AI workloads on client devices, particularly through AI personal computers (PCs) equipped with NPUs. As users increasingly demand responsive and personalized AI experiences, such as custom voice assistants, context-aware applications, and on-device large language model (LLM) fine-tuning, the method in this disclosure can enable a key differentiator: user-specific training without cloud dependency. This can both protect user data and reduce operational costs for OEMs (Original Equipment Manufacturers) and service providers.

Software like OpenVINO GenAI and hardware advances in integrated NPUs can create a compelling moment for proprietary solutions that extend beyond inference to encompass training. Supporting on-device LoRA fine-tuning can offer a significant competitive advantage in markets such as edge computing, privacy-first AI, and consumer personalization, establishing advantages in deployable, adaptive AI.

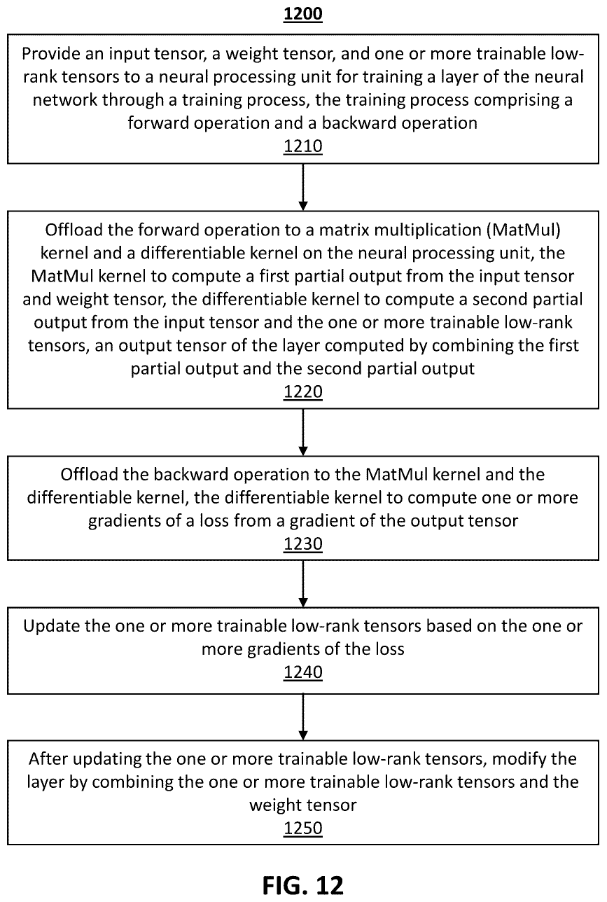

FIG. 12 is a flowchart of a method 1200 of training DNN, in accordance with various embodiments. The method 1200 may be performed by the AI system 100 in FIG. 1. Although the method 1200 is described with reference to the flowchart illustrated in FIG. 12, many other methods for training DNNs may alternatively be used. For example, the order of execution of the steps in FIG. 12 may be changed. As another example, some of the steps may be changed, eliminated, or combined.

The AI system 100 provides 1210 an input tensor, a weight tensor, and one or more trainable low-rank tensors to a NPU for training a layer of the neural network through a training process. The training process comprises a forward operation and a backward operation. In some embodiments, the one or more trainable low-rank tensors comprises a first trainable matrix and a second trainable matrix. A height of the first trainable matrix is smaller than a height of the input tensor or a height of the weight tensor. In some embodiments, a width of the first trainable matrix is the same as a width of the input tensor, and a height of the second trainable matrix is the same as a width of the weight tensor.

The AI system 100 offloads 1220 the forward operation to an MatMul kernel and a differentiable kernel on the NPU. The MatMul kernel is to compute a first partial output from the input tensor and weight tensor. The differentiable kernel is to compute a second partial output from the input tensor and the one or more trainable low-rank tensors. An output tensor of the layer is computed by combining the first partial output and the second partial output. In some embodiments, the differentiable kernel is to compute the second partial output by transposing the one or more trainable low-rank tensors and computing the second partial output from the input tensor and the transposed one or more trainable low-rank tensors. In some embodiments, the forward operation comprises computing the loss by applying a loss function on the output tensor and one or more reference values.

The AI system 100 offloads 1230 the backward operation to the MatMul kernel and the differentiable kernel. The differentiable kernel is to compute one or more gradients of a loss from a gradient of the output tensor. In some embodiments, the AI system 100 offloads an automatic differentiation module to the NPU. The automatic differentiation module is to compute the gradient of the output tensor. In some embodiments, the backward operation comprises computing the gradient of the output tensor based on the loss, the output tensor, and one or more reference values.

The AI system 100 updates 1240 the one or more trainable low-rank tensors based on the one or more gradients of the loss. In some embodiments, the AI system 100 updates the first trainable matrix based on a first gradient of the loss and a learning rate. The AI system 100 updates the second trainable matrix based on a second gradient of the loss and the learning rate.

The AI system 100 modifies 1250 the layer by combining the one or more trainable low-rank tensors and the weight tensor after updating the one or more trainable low-rank tensors. In some embodiments, the AI system 100 performs a matrix multiplication on the first trainable matrix and the second trainable matrix to compute a matrix that has the same shape as the weight tensor. The AI system 100 adds the matrix with the weight tensor, e.g., by performing an elementwise addition, to compute a new weight tensor. The AI system 100 replaces the weight tensor with the new weight tensor.

In some embodiments, the AI system 100 stores the input tensor, weight tensor, or one or more trainable low-rank tensors in a system memory that is on a separate chip from the NPU. The AI system 100 transfers, by a direct memory access engine, the input tensor, weight tensor, or one or more trainable low-rank tensors from the system memory to a local memory of the NPU. In some embodiments, the AI system 100 stores an intermediate tensor computed by the differential kernel during the forward operation into the system memory. The AI system 100 transfers, by the direct memory access engine, the intermediate tensor from the system memory to the local memory of the NPU for the backward operation.

FIG. 13 is a block diagram of a NPU 1300, in accordance with various embodiments. The NPU 1300 can execute DNNs. For instance, the NPU 1300 can execute layers in a DNN by carrying out neural network operations in the layers. The layers may be arranged in a sequence, and the NPU 1300 may execute the layers in the sequence. The execution of the DNN may be for training the DNN or for using the DNN to perform AI tasks. The NPU 1300 may also perform computations in backward passes for training DNNs. The NPU 1300 may be an example of the NPUs described above, e.g., the NPU 120B in FIG. 1. As shown in FIG. 13, the NPU 1300 includes a memory 1310, a DMA engine 1320, and compute blocks 1330 (individually referred to as “compute block 1330”). In other embodiments, alternative configurations, different or additional components may be included in the NPU 1300. For example, the NPU 1300 may include more than one memory 1310 or DMA engine 1320. As another example, the NPU 1300 may include a single compute block 1330. Further, functionality attributed to a component of the NPU 1300 may be accomplished by a different component included in the NPU 1300 or by a different system. A component of the NPU 1300 may be implemented in hardware, software, firmware, or some combination thereof.

The memory 1310 stores data associated with neural network operations performed by the NPU 1300. In some embodiments, the memory 1310 may store data to be used by the compute blocks 1330 for executing neural network operations. The memory 1310 may store inputs to DNNs and outputs of DNNs. The memory 1310 may also store activations (such as input activations and output activations of neural network operations) and weights (such as weights determined by training DNNs) in DNNs. In some embodiments, the memory 1310 may store activations and weights with floating-point precisions, such as FP4, SF4, NF4, FP16, BP16, FP32 and so on. The memory 1310 may also quantized activations or weights. The memory 1310 includes one or more dynamic random-access memories (DRAMs). In some embodiments, the memory 1310 is not part of the NPU 1300. The memory 1310 may be remote from the NPU 1300 and may be referred to as a remote memory. For instance, the memory 1310 may be on a separate chip from the NPU 1300. The memory 1310 may store remote tensors, e.g., remoted tensors used or generated for LoRA fine-tuning. The memory 1310 may be an example of the system memory 1010 in FIG. 10.

The DMA engine 1320 facilitates data transfer between the memory 1310 and the compute blocks 1330. For example, the DMA engine 1320 can read data (e.g., remote tensors) from the memory 1310 and write data into a local memory of a compute block 1330. As another example, the DMA engine 1320 can read data from a local memory of a compute block 1330 and write data into the memory 1310. For instance, the DMA engine 1320 may read input activations and weights of convolution from the memory 1310 and load the input activations and weights to one or more compute blocks 1330. The DMA engine 1320 may also write output activations of convolutions computed by one or more compute blocks 1330 to the memory 1310. The DMA engine 1320 provides a DMA feature that allows the compute block 1330 to initiate data transfer between the memory 1310 and the local memories of the compute blocks 1330 and to perform other operations while the data transfer is being conducted. In some embodiments, the DMA engine 1320 may read tensors from the memory 1310, modify the tensors in a way that is optimized for the compute block 1330 before it writes the tensors into the local memories of the compute blocks 1330.

The compute blocks 1330 perform neural network operations in DNNs. For instance, a compute block 1330 may execute a DNN layer by running one or more deep learning operations in the DNN layer. A compute block 1330 may execute a layer, or a portion of a layer, at a time. In some embodiments, the operations of the DNN layers may be run by multiple compute blocks 1330 in parallel. For instance, multiple compute blocks 1330 may each perform a portion of a workload for a neural network operation. Data may be shared between the compute blocks 1330. A compute block 1330 may also be referred to as a compute tile. The compute blocks 1330 may be capable of running various types of neural network operations, such as convolution, matrix multiplication, SoftMax operation, pooling, elementwise operation, linear operation, nonlinear operation, and so on. Neural network operations performed by the compute blocks 1330 include tensor operations, i.e., operations whose inputs are tensors or operations whose outputs are tensors. In an example, the compute block 1330 receives an input tensor and one or more convolutional kernels and performs a convolution with the input tensor and convolutional kernels. The result of the convolution may be an output tensor, which can be further computed, e.g., by the compute block 1330 or another compute block 1330.

In the embodiments of FIG. 13, each compute block 1330 includes a local memory 1340, a digital signal processor (DSP) 1350, and a data processing unit (DPU) 1355. The DPU 1355 includes an input delivery unit (IDU) 1360, a processing engine 1370, a post-processing engine 1380, and an output delivery unit (ODU) 1390. Some or all the components of the compute block 1330 can be implemented on the same chip. In other embodiments, alternative configurations, different or additional components may be included in the compute block 1330. Further, functionality attributed to a component of the compute block 1330 may be accomplished by a different component included in the compute block 1330, a different compute block 1330, another component of the NPU 1300, or a different system. A component of the compute block 1330 may be implemented in hardware, software, firmware, or some combination thereof.

The local memory 1340 is local to the corresponding compute block 1330. The local memory 1340 is accessible to both the DSP 1350 and DPU 1355. In the embodiments of FIG. 13, the local memory 1340 is inside the compute block 1330. In other embodiments, the local memory 1340 may be outside the compute block 1330. Data in the local memory 1340 may be transferred to or from the memory 1310, e.g., through the DMA engine 1320. In some embodiments, data in the local memory 1340 may be transferred to or from the local memory of another compute block 1330. The local memory 1340 may store data received, used, or generated by the IDU 1360, the processing engine 1370, the post-processing engine 1380, or the ODU 1390. Examples of the data may include input activations, weights, output activations, configuration parameters, and so on.

In some embodiments, the local memory 1340 includes one or more static random-access memories (SRAMs). The local memory 1340 may be byte-addressable, and each memory address identifies a single byte (eight bits) of storage. In some embodiments, the local memory 1340 may include memory banks. The number of data banks in the local memory 1340 may be 16, 64, 128, 1356, 512, 1324, 2048, or other numbers. A memory bank may include a plurality of storage units. In an example, a data bank may include 8, 16, 64, or a different number of storage units. A memory bank or a storage unit in a memory bank may have a memory address. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the local memory 1340 in a single read cycle. In other embodiments, 16 bits can be transferred from the local memory 1340 in multiple read cycles, such as two cycles.

The DSP 1350 performs computations in DNN layers, including computations in group quantization-based neural network operations. In some embodiments, the DSP 1350 can perform generic computations such as addition, subtraction, multiplication, division, logical, bitwise operations, and other nonlinear computations (in terms of table look-up or polynomial approximation). The DSP 1350 may be a very long instruction word (VLIW) processor. In some embodiments, the DSP 1350 may have an architecture optimized for the operational needs of digital signal processing. In some embodiments, the DSP 1350 may perform some computations in a neural network operation, while other computations in the neural network operation may be performed by the DPU 1355. The DSP 1350 may support non-traditional operations or non-MatMul or non-convolution-based operations within DNNs.

In some embodiments, the DSP 1350 may operate in accordance with a clock signal. For instance, the timing when the DSP 1350 can execute instructions may be synchronized with the clock signal. In some embodiments, the DSP 1350 may be pipelined along with the DMA engine 1320 or the DPU 1355, thereby enabling parallel computations to improve overall performance. The DSP 1350 may be implemented on a microprocessor chip, which may be separate from a chip implementing the DPU 1355. In some embodiments, the DSP 1350 may be a Streaming Hybrid Architecture Vector Engine (SHAVE) processor. Even though FIG. 13 shows a single DSP, the compute block 1330 may include multiple DSPs. The DSPs may be arranged in an array.

The IDU 1360 loads data from the local memory 1340 to the processing engine 1370 or to the post-processing engine 1380. The IDU 1360 may read tensors from the local memory 1340. The tensors may include activation tensors, weights tensor, and so on. The IDU 1360 may perform group-wise loading of activations or weights. In some embodiments, the IDU 1360 may read data from the local memory 1340 and write the data into storage units in the processing engine 1370. For instance, the IDU 1360 may load activations into activation register files in the processing engine 1370 and load weights into weight register files in the processing engine 1370. The IDU 1360 may have an activation reader for loading activations and a weight reader for loading weights. In some embodiments, the IDU 1360 may read configuration parameters from the local memory 1340 and load the configuration parameters into configuration registers or other configurable components (e.g., LUTs) of the processing engine 1370 or post-processing engine 1380.

The processing engine 1370 performs operations in DNNs. The processing engine 1370 may include one or more processing cells. In some embodiments, the processing cells may be arranged in one or more rows and one or more columns in the processing engine 1370. Each processing cell may include processing elements (PEs) that may be arranged in an array that includes rows and columns. All the PEs in the processing engine 1370 may constitute a bigger array that includes more rows and columns. An example PE may be or may include one or more multiply-accumulate (MAC) units that can perform MAC operations. In some embodiments (e.g., embodiments where the compute block 1330 executes a convolutional layer), a computation in an MAC unit may be an MAC operation on an activation operand and a weight operand. The activation operand may be an activation tensor that may include one or more activations in the input tensor of the convolution. Different activations may be in different input channels. The weight operand may be a weight tensor that may include one or more weights in the filter of the convolution. The values of the weights are determined through training the DNN or compressing the neural network operation after training. The weights in the weight operand may be in different input channels. In some embodiments, the activation operand or weight operand is a vector along the input channel dimension.

In some embodiments, an MAC unit includes one or more multipliers for performing multiplications. An MAC unit may also include one or more accumulators (“adders”) for performing accumulations. An MAC unit may also include one or more shifters to facilitate mixed-precision computations. A column of MAC units is referred to as an MAC column. An MAC column may be associated with one or more MAC lanes. A MAC lane is a path for loading data e.g., by the IDU 1360, into an MAC column. A MAC lane may be also referred to as a data transmission lane or data loading lane. An MAC column may have multiple MAC lanes. The loading bandwidth of the MAC column is an aggregation of the loading bandwidths of all the MAC lanes associated with the MAC column. With a certain number of MAC lanes, data can be fed into the same number of independent MAC units simultaneously. In some embodiments where an MAC column has four MAC lanes for feeding activations or weights into the MAC column and each MAC lane may have a bandwidth of 16 bytes, the four MAC lanes can have a total loading bandwidth of 64 bytes.

In some embodiments, a processing cell may have a sparsity logic unit for accelerating computations in DNNs based on data sparsity. For instance, the sparsity logic unit may obtain or generate a sparsity bitmap and use the sparsity bitmap to identify nonzero values in the activation register files or weight registers files and send nonzero values to the PEs for performing computation, while zero values in the activation register files or weight registers files are skipped.

The post-processing engine 1380 processes outputs of the processing engine 1370. The post-processing engine 1380 may include one or more post-processing elements (PPEs). In some embodiments, the PPEs in the post-processing engine 1380 may be arranged in an array that has rows and columns. In some embodiments, the post-processing engine 1380 computes activation functions. The post-processing engine 1380 may receive outputs of the processing engine 1370 as inputs to the activation functions. In addition or alternative to activation functions, the post-processing engine 1380 may perform other types of post processing on outputs of the processing engine 1370. For instance, the post-processing engine 1380 may apply a bias on an output of the processing engine 1370. In some embodiments, the post-processing engine 1380 may be bypassed for certain neural network operations.

The ODU 1390 drains data from the processing engine 1370 or from the post-processing engine 1380, e.g., from register files in the processing engine 1370 or from the post-processing engine 1380. The drain module may write the data to the local memory 1340. The drained data may be tensors, such as output tensors of neural network operations. In some embodiments, the ODU 1390 may drain data on a cell level. For each processing cell, the ODU 1390 may drain outputs of PEs in the processing cell based on a row index or column index of each PE. For instance, the ODU 1390 may use a sequence of cycles to drain data from a processing cell. The ODU 1390 may drain the output of some of the PEs in each cycle. The sequence of the cycles may be configured based on a configuration parameter indicating the operation mode of the IDU 1360.

In some embodiments, the ODU 1390 includes sparsity encoding logic that can convert outputs of the processing engine 1370 from a dense format to a sparse format. For instance, the ODU 1390 may be implemented with one or more sparsity encoders. A sparsity encoder converts dense data to compressed data based on sparsity in the dense data. For instance, the sparsity encoder may remove zeros from data computed by the processing engine 1370. The sparsity encoder may also generate sparsity maps that represent sparsity in the dense data.

In some embodiments, the data drained from the processing engine 1370 may be output data elements of a DNN layer. The sparsity encoder may generate a compressed version of the output tensor. The sparsity encoder may identify every zero activation in the output tensor and remove these activations from the output tensor to generate a compressed activation tensor (aka “sparse activation tensor”). The sparsity encoder may also generate one or more sparsity maps for the output tensor. A sparsity map may indicate sparsity in at least part of the output tensor. The sparsity map may include sparsity elements (e.g., bits), each of which corresponds to a different activation in the vector and indicates whether the corresponding activation is zeroed or not.

The ODU 1390 may write the compressed activation tensor and the one or more sparsity maps into the local memory 1340. The sparse activation tensor and the one or more sparsity maps may be further loaded to the memory 1310, e.g., through the DMA engine 1320. Additionally or alternatively, the sparse activation tensor and the one or more sparsity maps may be loaded by the IDU 1360 to the processing engine 1370 for further computation, e.g., for performing a deep learning operation in the next layer.

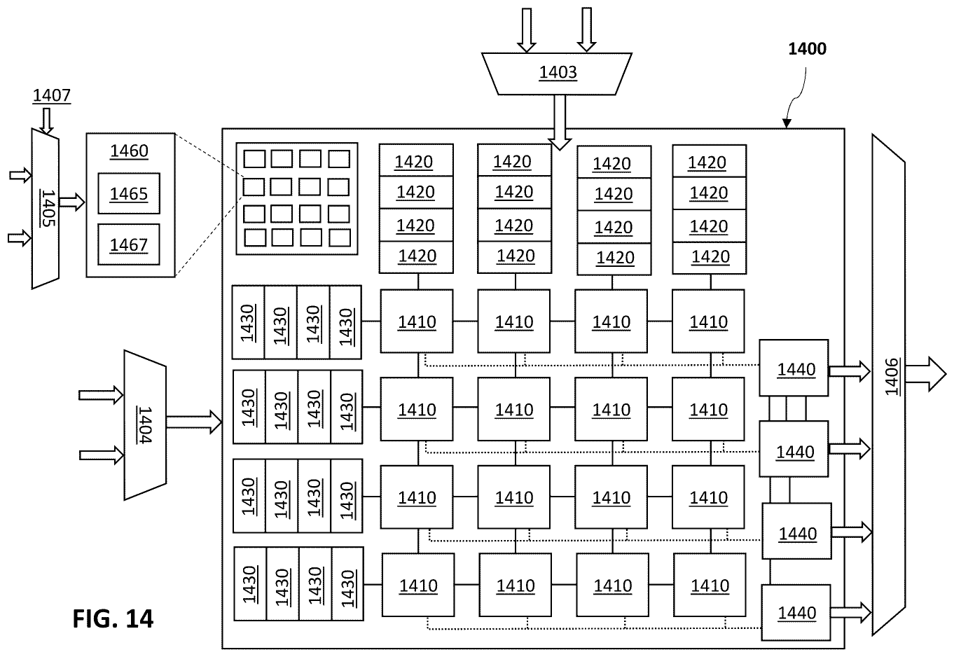

FIG. 14 illustrates an example sparse cell 1400, in accordance with various embodiments. The sparse cell 1400 may be a processing cell in a processing engine, e.g., the processing engine 1370 in FIG. 13. The sparse cell 1400 includes 16 MAC units 1410 (individually referred to as “MAC unit 1410”), which constitutes a MAC array having four rows and four columns. The MAC array has a spatial shape of 4×4, meaning the height of the MAC array is four and the width of the MAC array is also 14. The sparse cell 1400 also includes 16 weight register files 1420 (individually referred to as “weight register file 1420”), 16 activation register files 1430 (individually referred to as “activation register file 1430”), four row buffers 1440 (individually referred to as “row buffer 1440”), and acceleration modules 1460 (individually referred to as “acceleration module 1460”). In other embodiments, the sparse cell 1400 may include fewer, more, or different components. For example, the sparse cell 1400 may include a different number of MAC units 1410, weight register files 1420, activation register files 1430, row buffers 1440, or acceleration modules 1460. As another example, the sparse cell 1400 may include column buffers in lieu of or in addition to the row buffers 1440. Also, the shape (e.g., the height or width) of the MAC array may be different.

The MAC units 1410 are configured to perform MAC operations. Each MAC unit 1410 may include one or more multipliers and one or more adders. A multiplier may multiply an activation with a weight at a time to compute a product. In some embodiments (e.g., embodiments where the MAC unit 1410 includes multiple multipliers), the multipliers may operate simultaneously to process multiple activation-weight pairs and compute multiple products in one cycle. An adder may accumulate products computed by the multipliers. Even though not shown in FIG. 14, the sparse cell may include an adder tree including a plurality of adder tiers. The first tier may receive outputs of a plurality of MAC units 1410. The number of adders in the first tier may be half of the number of the MAC units 1410, and each adder may accumulate the outputs of two MAC units 1410. The second tier may receive outputs of adders in the first tier. The number of adders in the second tier may be half of the number of adders in the first tier, and each adder in the second tier may accumulate the outputs of two adders in the first tier. The adder tree may include one or more other tiers. The last tier may include a single adder that accumulates outputs of adders in the second last tier to compute a partial sum of the sparse cell 1400.

The weight register files 1420 store weights to be processed in MAC operations. In the embodiments of FIG. 14, four weight register files 1420 are grouped into a storage set that stores data to be used by a column of MAC units 1410. There are four storage sets corresponding to the four columns of MAC units 1410. In some embodiments, a weight register file 1420 may correspond to a MAC unit 1410 and store data to be processed by the MAC unit. In some embodiments, all the 16 weight register files 1420 constitute a weight storage unit.

The activation register files 1430 stores activations to be processed in MAC operations. In the embodiments of FIG. 14, four activation register files 1430 are grouped into a storage set that stores data to be used by a row of MAC units 1410. There are four storage sets corresponding to the four rows of MAC units 1410. In some embodiments, an activation register file 1430 may correspond to a MAC unit 1410 and store data to be processed by the MAC unit. In some embodiments, all the 16 activation register files 1430 constitute an activation storage unit. The row buffers 1440 store outputs of the MAC units 1410. Each row buffer 1440 may drain outputs of a single row of MAC units 1410.

The acceleration module 1460 facilitates acceleration of computations in the sparse cell 1400 based on mixed formats of weights. In the embodiments of FIG. 14, each acceleration module 1460 may control acceleration of computations in a different MAC unit 1410. The number of acceleration modules 1460 in the sparse cell 1400 is the same as the number of MAC units 1410 in the sparse cell 1400. In other embodiments, an acceleration module 1460 may control acceleration in multiple MAC units 1410. As shown FIG. 14, each acceleration module 1460 includes a storage unit 1465 and a control logic 1467. The storage unit 1465 stores mixed-format maps. The control logic 1467 may control distributions of activations and weights stored from the weight register files 1420 and the activation register files 1430 to the MAC units 1410 based on mixed-format maps. In some embodiments, the control logic 1467 may distribute a weight operand and a corresponding activation operation to a MAC unit 1410 for an MAC operation. The weight operand may be a subblock (e.g., a column) of a weight block. All the weights in the weight operand may be in the same output channel and have the same spatial position, but the weights may be in different input channels from each other.

In some embodiments, a weight operand may include one or more uncompressed weight and one or more compressed weights. The control logic 1467 may distribute compressed weights to MAC units 1410 in a different manner from which the control logic 1467 distributes uncompressed weights. In some embodiments (e.g., embodiments in which the compressed weights are zeros), the control logic 1467 may select nonzero weights stored in the weight register files 1420 based on the mixed-format map and distribute these nonzero weights to the MAC unit 1410 for computation. The control logic 1467 may also distribute activations, which correspond to the nonzero weights, to the MAC unit 1410 from in the activation register files 1430. The control logic 1467 may ignore zero weights and activations corresponding the zero weights so that these weights and activations can be skipped from computation.

In other embodiments (e.g., embodiments in which the compressed weights have a lower precision than the uncompressed weights), the control logic 1467 may distribute both compressed weights and uncompressed weights to the MAC unit 1410 but in different manners. For example, the control logic 1467 may distribute one compressed weight to the MAC unit 1410 for one computation cycle of the MAC unit 1410 but distribute one uncompressed weight to the MAC unit 1410 for multiple computation cycles of the MAC unit 1410. The MAC unit 1410 may have a multiplier that can compute a product of a compressed weight with its corresponding activation in one computation cycle. The multiplier may compute multiple products for an uncompressed weight. Each of these products may be a result of multiplying a portion of the uncompressed weight with the corresponding activation in one computation cycle. One or more of these products may be shifted and then accumulated with one or more other products to compute the product of the uncompressed weight and the activation. As another example, the control logic 1467 may distribute multiple compressed weights to the MAC unit 1410 for one computation cycle of the MAC unit 1410 but distribute one uncompressed weight to the MAC unit 1410 for one computation cycle of the MAC unit 1410. The MAC unit 1410 in this example may have multiple multipliers that can compute multiple products for a uncompressed weight in one operating cycle, in which each multiplier may multiply a portion of the uncompressed weight with the corresponding activation. Each multiplier may multiply a compressed weight with the corresponding activation in one compute cycle so that multiple multipliers can handle multiple uncompressed weights in one computation cycle.

As shown in FIG. 14, the sparse cell 1400 is associated with multiplexers (MUXs) 1403, 1404, 1405, and 1406. In other embodiments, the sparse cell 1400 may be associated with a different number of MUXs or other devices. The MUX 1403 facilitates loading weights, e.g., from the local memory 1340 in FIG. 13, into the weight register files 1420. The MUX 1404 facilitates loading activations, e.g., from the local memory 1340 in FIG. 13, into the activation register files 1430. The MUX 1405 facilitates loading mixed-format maps into the storage unit 1465. The MUX 1406 may be a drain MUX that can facilitate draining outputs of the MAC units 1410, e.g., to the local memory 1340 in FIG. 13.

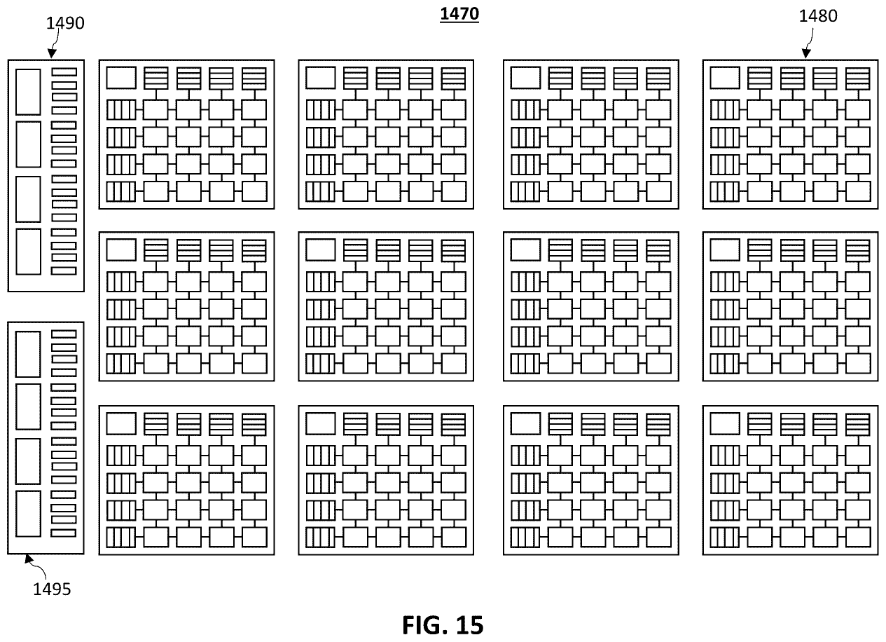

FIG. 15 illustrates a sparse cell array 1470, in accordance with various embodiments. The sparse cell array 1470 may be an example of the processing engine 1370 in FIG. 13. In FIG. 15, the sparse cell array 1470 includes sparse cells 1480 (individually referred to as “sparse cell 1480”) arranged in four columns and four rows, an activation memory 1490, and a weight memory 1495. In other embodiments, the sparse cell array 1470 may include fewer, more, or different components. For instance, the sparse cell array 1470 may include a different number of columns, rows, or sparse cells 1480.

Each sparse cell 1480 may perform accelerated MAC operations. MAC operations in the sparse cells 1480 may be accelerated based on mixed formats of weights. An embodiment of a sparse cell 1480 may be the sparse cell 1400 in FIG. 14. The activation memory 1490 stores activations, such as activations in input tensors of neural network operations. Activations may be loaded from the activation memory 1490 to sparse cells 1480, e.g., to activation register files. The weight memory 1495 stores weights, such as weights in filters of neural network operations. Weights may be loaded from the weight memory 1495 to sparse cells 1480, e.g., to weight register files. The activation memory 1490 or weight memory 1495 may be a buffer.

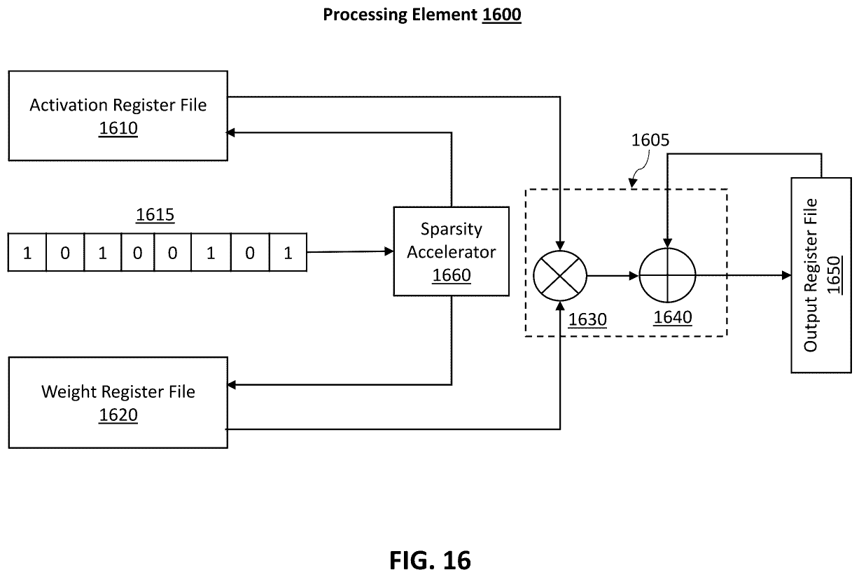

FIG. 16 illustrates an example PE 1600, in accordance with various embodiments. The PE 1600 may be a unit component of a processing cell, e.g., a processing cell in the processing engine 1370 in FIG. 13. In the embodiments of FIG. 16, the PE 1600 includes an MAC unit 1605, an activation register file 1610, a weight register file 1620, an output register file 1650, and a sparsity accelerator 1660. The MAC unit 1605 includes a multiplier 1630 and an adder 1640. In other embodiments, the PE 1600 may include fewer, more, or different components.

The activation register file 1610 stores an activation operand, which may be a context. The activation register file 1610 may be an example of the activation register files 1430 in FIG. 14. The weight register file 1620 stores a weight operand. The weight register file 1620 may be an example of the weight register files 1420 in FIG. 14. The activation operand and weight operand may be loaded from a memory (e.g., the memory 340) into the activation register file 1610 and the weight register file 1620, respectively. The sparsity accelerator 1660 receives a sparsity bitmap 1615 that corresponds to the sparse tensor in the weight register file 1620. The sparsity bitmap 1615 may be a combined sparsity bitmap when the MAC unit 1605 operates in a combined compute mode. The sparsity bitmap 1615 may be an activation sparsity bitmap when the MAC unit 1605 operates in an activation compute mode. The sparsity bitmap 1615 may be a weight sparsity bitmap when the MAC unit 1605 operates in a weight compute mode. The sparsity bitmap 1615 may have the same size (e.g., the same number of elements) as or a larger size than the activation operand or the weight operand.

Using the sparsity bitmap 1615, the sparsity accelerator 1660 selects four activations from the activation register file 1610 and selects four weights from the weight register file 1620. The sparsity accelerator 1660 transmits the selected activations and weights to the multiplier 1630. These selected data elements correspond to the nonzero elements of the sparsity bitmap 1615. The four selected activations and the four selected weights may constitute four activation-weight pairs. The multiplier 1630 may compute a product based on each activation-weight pair and therefore, compute four products in total. The four products may be provided to the adder 1640. Even though FIG. 16 shows a single multiplier 1630, the MAC unit 1605 may include multiple multipliers that can perform multiple multiplication operations at the same time.

The adder 1640 accumulates the four products and computes a unit-level internal partial sum. The four unselected elements of the dense tensor are not processed to save power and time, which would not impact the value of the unit-level internal partial sum. For instance, when the dense tensor is a dense activation tensor, the weights corresponding to the unselected activations are zeros so the products of the unselected activations and the weights would all be zero and have no contribution to the unit-level internal partial sum or other partial sums computed by the sparse cell. Similarly, when the dense tensor is a dense weight tensor, the activations corresponding to the unselected weights are zeros so the products of the unselected weights and the activations would all be zero and have no contribution to the unit-level internal partial sum or other partial sums computed by the sparse cell. In other embodiments, the MAC unit 1605 may operate in a dense mode in which the sparsity bitmap 1615 is not used and the sparsity accelerator 1660 is inactive. The MAC unit 1605 may process all the activations in the activation operand and all the weights in the weight operand.

The unit-level internal partial sum may be stored in the output register file 1650. In some embodiments, the unit-level internal partial sum may be used multiple times. For instance, the activation operand may represent N data blocks in the input tensor of the convolution, where N is an integer greater than 1. Instead of processing all the N data blocks to compute N unit-level internal partial sums, the unit-level internal partial sum is computed once and used N times in the convolutional layers as N unit-level internal partial sums.

In some embodiments, the PE 1600 receives one or more PE-level internal partial sums from one or more other PEs. The adder 1640 or an accumulator (not shown in FIG. 16) can accumulate the one or more PE-level internal partial sums with the PE-level internal partial sum of the PE 1600 and store the result of the accumulation (i.e., a multi-PE internal partial sum) in the output register file 1650. The one or more other PEs may be in the same column as the PE 1600 in a sparse cell. The multi-unit internal partial sum may be a column-level internal partial sum. In some embodiments, the PE-level internal partial sum of the PE 1600 or the multi-unit internal partial sum may be sent to one or more other PEs for further accumulation.

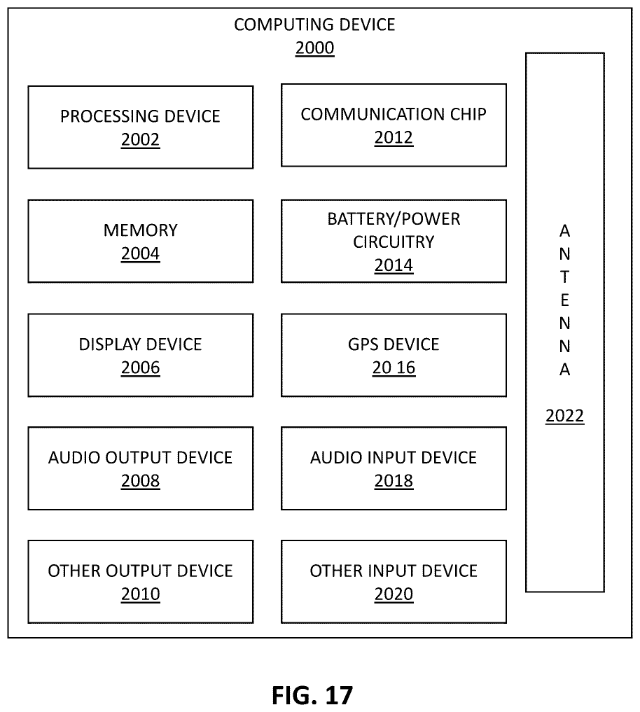

FIG. 17 is a block diagram of an example computing device 2000, in accordance with various embodiments. In some embodiments, the computing device 2000 can be used as at least part of the AI system 100 in FIG. 1. A number of components are illustrated in FIG. 17 as included in the computing device 2000, but any one or more of these components may be omitted or duplicated, as suitable for the application. In some embodiments, some or all of the components included in the computing device 2000 may be attached to one or more motherboards. In some embodiments, some or all of these components are fabricated onto a single system on a chip (SoC) die. Additionally, in various embodiments, the computing device 2000 may not include one or more of the components illustrated in FIG. 17, but the computing device 2000 may include interface circuitry for coupling to the one or more components. For example, the computing device 2000 may not include a display device 2006, but may include display device interface circuitry (e.g., a connector and driver circuitry) to which a display device 2006 may be coupled. In another set of examples, the computing device 2000 may not include an audio input device 2018 or an audio output device 2008 but may include audio input or output device interface circuitry to which an audio input device 2018 or audio output device 2008 may be coupled.

The computing device 2000 may include a processing device 2002 (e.g., one or more processing devices). The processing device 2002 processes electronic data from registers and/or memory to transform that electronic data into other electronic data that may be stored in registers and/or memory. The computing device 2000 may include a memory 2004, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 2004 may include memory that shares a die with the processing device 2002. In some embodiments, the memory 2004 includes one or more non-transitory computer-readable media storing instructions executable to perform operations for fine-tuning DNNs (e.g., the method 1200 described in conjunction with FIG. 12) or some operations performed by one or more components of the AI system 100 in FIG. 1. The instructions stored in the one or more non-transitory computer-readable media may be executed by the processing device 2002.

In some embodiments, the computing device 2000 may include a communication chip 2012 (e.g., one or more communication chips). For example, the communication chip 2012 may be configured for managing wireless communications for the transfer of data to and from the computing device 2000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 2012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2012 may operate in accordance with other wireless protocols in other embodiments. The computing device 2000 may include an antenna 2022 to facilitate wireless communications and/or to receive other wireless communications (such as AM or FM radio transmissions).

In some embodiments, the communication chip 2012 may manage wired communications, such as electrical, optical, or any other suitable communication protocols (e.g., the Ethernet). As noted above, the communication chip 2012 may include multiple communication chips. For instance, a first communication chip 2012 may be dedicated to shorter-range wireless communications such as Wi-Fi or Bluetooth, and a second communication chip 2012 may be dedicated to longer-range wireless communications such as global positioning system (GPS), EDGE, GPRS, CDMA, WiMAX, LTE, EV-DO, or others. In some embodiments, a first communication chip 2012 may be dedicated to wireless communications, and a second communication chip 2012 may be dedicated to wired communications.

The computing device 2000 may include battery/power circuitry 2014. The battery/power circuitry 2014 may include one or more energy storage devices (e.g., batteries or capacitors) and/or circuitry for coupling components of the computing device 2000 to an energy source separate from the computing device 2000 (e.g., AC line power).

The computing device 2000 may include a display device 2006 (or corresponding interface circuitry, as discussed above). The display device 2006 may include any visual indicators, such as a heads-up display, a computer monitor, a projector, a touchscreen display, a liquid crystal display (LCD), a light-emitting diode display, or a flat panel display, for example.

The computing device 2000 may include an audio output device 2008 (or corresponding interface circuitry, as discussed above). The audio output device 2008 may include any device that generates an audible indicator, such as speakers, headsets, or earbuds, for example.

The computing device 2000 may include an audio input device 2018 (or corresponding interface circuitry, as discussed above). The audio input device 2018 may include any device that generates a signal representative of a sound, such as microphones, microphone arrays, or digital instruments (e.g., instruments having a musical instrument digital interface (MIDI) output).

The computing device 2000 may include a GPS device 2016 (or corresponding interface circuitry, as discussed above). The GPS device 2016 may be in communication with a satellite-based system and may receive a location of the computing device 2000, as known in the art.

The computing device 2000 may include another output device 2010 (or corresponding interface circuitry, as discussed above). Examples of the other output device 2010 may include an audio codec, a video codec, a printer, a wired or wireless transmitter for providing information to other devices, or an additional storage device.

The computing device 2000 may include another input device 2020 (or corresponding interface circuitry, as discussed above). Examples of the other input device 2020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2000 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 2000 may be any other electronic device that processes data.

The following paragraphs provide various examples of the embodiments disclosed herein.

Example 1 provides one or more non-transitory computer-readable media storing instructions executable to perform operations for training a neural network, the operations including providing an input tensor, a weight tensor, and one or more trainable low-rank tensors to a neural processing unit for training a layer of the neural network through a training process, the training process including a forward operation and a backward operation; offloading the forward operation to a matrix multiplication (MatMul) kernel and a differentiable kernel on the neural processing unit, the MatMul kernel to compute a first partial output from the input tensor and weight tensor, the differentiable kernel to compute a second partial output from the input tensor and the one or more trainable low-rank tensors, an output tensor of the layer computed by combining the first partial output and the second partial output; offloading the backward operation to the MatMul kernel and the differentiable kernel, the differentiable kernel to compute one or more gradients of a loss from a gradient of the output tensor; updating the one or more trainable low-rank tensors based on the one or more gradients of the loss; and after updating the one or more trainable low-rank tensors, modifying the layer by combining the one or more trainable low-rank tensors and the weight tensor.

Example 2 provides the one or more non-transitory computer-readable media of example 1, in which the one or more trainable low-rank tensors includes a first trainable matrix and a second trainable matrix, in which a height of the first trainable matrix is smaller than a height of the input tensor or a height of the weight tensor.

Example 3 provides the one or more non-transitory computer-readable media of example 2, in which a width of the first trainable matrix is the same as a width of the input tensor, in which a height of the second trainable matrix is the same as a width of the weight tensor.

Example 4 provides the one or more non-transitory computer-readable media of example 2 or 3, in which updating the one or more trainable low-rank tensors includes updating the first trainable matrix based on a first gradient of the loss and a learning rate; and updating the second trainable matrix based on a second gradient of the loss and the learning rate.

Example 5 provides the one or more non-transitory computer-readable media of any one of examples 1-4, in which the operations further include storing the input tensor, weight tensor, or one or more trainable low-rank tensors in a system memory that is on a separate chip from the neural processing unit; and transferring, by a direct memory access engine, the input tensor, weight tensor, or one or more trainable low-rank tensors from the system memory to a local memory of the neural processing unit.

Example 6 provides the one or more non-transitory computer-readable media of example 5, in which the operations further include storing an intermediate tensor computed by the differential kernel during the forward operation into the system memory; and transferring, by the direct memory access engine, the intermediate tensor from the system memory to the local memory of the neural processing unit for the backward operation.

Example 7 provides the one or more non-transitory computer-readable media of any one of examples 1-6, in which the differentiable kernel is to compute the second partial output by: transposing the one or more trainable low-rank tensors; and computing the second partial output from the input tensor and the transposed one or more trainable low-rank tensors.

Example 8 provides the one or more non-transitory computer-readable media of any one of examples 1-7, in which the operations further include offloading an automatic differentiation module to the neural processing unit, the automatic differentiation module to compute the gradient of the output tensor.

Example 9 provides the one or more non-transitory computer-readable media of any one of examples 1-8, in which the forward operation includes computing the loss by applying a loss function on the output tensor and one or more reference values.

Example 10 provides the one or more non-transitory computer-readable media of any one of examples 1-9, in which the backward operation includes computing the gradient of the output tensor based on the loss, the output tensor, and one or more reference values.

Example 11 provides a method of training a neural network, including providing an input tensor, a weight tensor, and one or more trainable low-rank tensors to a neural processing unit for training a layer of the neural network through a training process, the training process including a forward operation and a backward operation; offloading the forward operation to a matrix multiplication (MatMul) kernel and a differentiable kernel on the neural processing unit, the MatMul kernel to compute a first partial output from the input tensor and weight tensor, the differentiable kernel to compute a second partial output from the input tensor and the one or more trainable low-rank tensors, an output tensor of the layer computed by combining the first partial output and the second partial output; offloading the backward operation to the MatMul kernel and the differentiable kernel, the differentiable kernel to compute one or more gradients of a loss from a gradient of the output tensor; updating the one or more trainable low-rank tensors based on the one or more gradients of the loss; and after updating the one or more trainable low-rank tensors, modifying the layer by combining the one or more trainable low-rank tensors and the weight tensor.

Example 12 provides the method of example 11, in which the one or more trainable low-rank tensors includes a first trainable matrix and a second trainable matrix, in which a height of the first trainable matrix is smaller than a height of the input tensor or a height of the weight tensor.

Example 13 provides the method of example 12, in which a width of the first trainable matrix is the same as a width of the input tensor, in which a height of the second trainable matrix is the same as a width of the weight tensor.

Example 14 provides the method of example 12 or 13, in which updating the one or more trainable low-rank tensors includes updating the first trainable matrix based on a first gradient of the loss and a learning rate; and updating the second trainable matrix based on a second gradient of the loss and the learning rate.

Example 15 provides the method of any one of examples 11-14, further including storing the input tensor, weight tensor, or one or more trainable low-rank tensors in a system memory that is on a separate chip from the neural processing unit; and transferring, by a direct memory access engine, the input tensor, weight tensor, or one or more trainable low-rank tensors from the system memory to a local memory of the neural processing unit.

Example 16 provides the method of example 15, further including storing an intermediate tensor computed by the differential kernel during the forward operation into the system memory; and transferring, by the direct memory access engine, the intermediate tensor from the system memory to the local memory of the neural processing unit for the backward operation.

Example 17 provides the method of any one of examples 11-16, in which the differentiable kernel is to compute the second partial output by: transposing the one or more trainable low-rank tensors; and computing the second partial output from the input tensor and the transposed one or more trainable low-rank tensors.

Example 18 provides the method of any one of examples 11-17, further including offloading an automatic differentiation module to the neural processing unit, the automatic differentiation module to compute the gradient of the output tensor.

Example 19 provides the method of any one of examples 11-18, in which the forward operation includes computing the loss by applying a loss function on the output tensor and one or more reference values.

Example 20 provides the method of any one of examples 11-19, in which the backward operation includes computing the gradient of the output tensor based on the loss, the output tensor, and one or more reference values.

Example 21 provides an apparatus including a computer processor for executing computer program instructions; and a non-transitory computer-readable memory storing computer program instructions executable by the computer processor to perform operations for training a neural network, the operations including providing an input tensor, a weight tensor, and one or more trainable low-rank tensors to a neural processing unit for training a layer of the neural network through a training process, the training process including a forward operation and a backward operation, offloading the forward operation to a matrix multiplication (MatMul) kernel and a differentiable kernel on the neural processing unit, the MatMul kernel to compute a first partial output from the input tensor and weight tensor, the differentiable kernel to compute a second partial output from the input tensor and the one or more trainable low-rank tensors, an output tensor of the layer computed by combining the first partial output and the second partial output, offloading the backward operation to the MatMul kernel and the differentiable kernel, the differentiable kernel to compute one or more gradients of a loss from a gradient of the output tensor, updating the one or more trainable low-rank tensors based on the one or more gradients of the loss, and after updating the one or more trainable low-rank tensors, modifying the layer by combining the one or more trainable low-rank tensors and the weight tensor.

Example 22 provides the apparatus of example 21, in which the one or more trainable low-rank tensors includes a first trainable matrix and a second trainable matrix, in which a height of the first trainable matrix is smaller than a height of the input tensor or a height of the weight tensor.

Example 23 provides the apparatus of example 21 or 22, in which updating the one or more trainable low-rank tensors includes updating the first trainable matrix based on a first gradient of the loss and a learning rate; and updating the second trainable matrix based on a second gradient of the loss and the learning rate.

Example 24 provides the apparatus of any one of examples 21-23, in which the operations further include storing the input tensor, weight tensor, or one or more trainable low-rank tensors in a system memory that is on a separate chip from the neural processing unit; and transferring, by a direct memory access engine, the input tensor, weight tensor, or one or more trainable low-rank tensors from the system memory to a local memory of the neural processing unit.

Example 25 provides the apparatus of example 24, in which the operations further include storing an intermediate tensor computed by the differential kernel during the forward operation into the system memory; and transferring, by the direct memory access engine, the intermediate tensor from the system memory to the local memory of the neural processing unit for the backward operation.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. One or more non-transitory computer-readable media storing instructions executable to perform operations for training a neural network, the operations comprising:
providing an input tensor, a weight tensor, and one or more trainable low-rank tensors to a neural processing unit for training a layer of the neural network through a training process, the training process comprising a forward operation and a backward operation;
offloading the forward operation to a matrix multiplication (MatMul) kernel and a differentiable kernel on the neural processing unit, the MatMul kernel to compute a first partial output from the input tensor and weight tensor, the differentiable kernel to compute a second partial output from the input tensor and the one or more trainable low-rank tensors, an output tensor of the layer computed by combining the first partial output and the second partial output;
offloading the backward operation to the MatMul kernel and the differentiable kernel, the differentiable kernel to compute one or more gradients of a loss from a gradient of the output tensor;
updating the one or more trainable low-rank tensors based on the one or more gradients of the loss; and
after updating the one or more trainable low-rank tensors, modifying the layer by combining the one or more trainable low-rank tensors and the weight tensor.

2. The one or more non-transitory computer-readable media of claim 1, wherein the one or more trainable low-rank tensors comprises a first trainable matrix and a second trainable matrix, wherein a height of the first trainable matrix is smaller than a height of the input tensor or a height of the weight tensor.

3. The one or more non-transitory computer-readable media of claim 2, wherein a width of the first trainable matrix is the same as a width of the input tensor, wherein a height of the second trainable matrix is the same as a width of the weight tensor.

4. The one or more non-transitory computer-readable media of claim 2, wherein updating the one or more trainable low-rank tensors comprises:
updating the first trainable matrix based on a first gradient of the loss and a learning rate; and
updating the second trainable matrix based on a second gradient of the loss and the learning rate.

5. The one or more non-transitory computer-readable media of claim 1, wherein the operations further comprise:
storing the input tensor, weight tensor, or one or more trainable low-rank tensors in a system memory that is on a separate chip from the neural processing unit; and
transferring, by a direct memory access engine, the input tensor, weight tensor, or one or more trainable low-rank tensors from the system memory to a local memory of the neural processing unit.

6. The one or more non-transitory computer-readable media of claim 5, wherein the operations further comprise:
storing an intermediate tensor computed by the differential kernel during the forward operation into the system memory; and
transferring, by the direct memory access engine, the intermediate tensor from the system memory to the local memory of the neural processing unit for the backward operation.

7. The one or more non-transitory computer-readable media of claim 1, wherein the differentiable kernel is to compute the second partial output by:
transposing the one or more trainable low-rank tensors; and
computing the second partial output from the input tensor and the transposed one or more trainable low-rank tensors.

8. The one or more non-transitory computer-readable media of claim 1, wherein the operations further comprise:
offloading an automatic differentiation module to the neural processing unit, the automatic differentiation module to compute the gradient of the output tensor.

9. The one or more non-transitory computer-readable media of claim 1, wherein the forward operation comprises computing the loss by applying a loss function on the output tensor and one or more reference values.

10. The one or more non-transitory computer-readable media of claim 1, wherein the backward operation comprises computing the gradient of the output tensor based on the loss, the output tensor, and one or more reference values.

11. A method of training a neural network, comprising:
providing an input tensor, a weight tensor, and one or more trainable low-rank tensors to a neural processing unit for training a layer of the neural network through a training process, the training process comprising a forward operation and a backward operation;
offloading the forward operation to a matrix multiplication (MatMul) kernel and a differentiable kernel on the neural processing unit, the MatMul kernel to compute a first partial output from the input tensor and weight tensor, the differentiable kernel to compute a second partial output from the input tensor and the one or more trainable low-rank tensors, an output tensor of the layer computed by combining the first partial output and the second partial output;
offloading the backward operation to the MatMul kernel and the differentiable kernel, the differentiable kernel to compute one or more gradients of a loss from a gradient of the output tensor;
updating the one or more trainable low-rank tensors based on the one or more gradients of the loss; and
after updating the one or more trainable low-rank tensors, modifying the layer by combining the one or more trainable low-rank tensors and the weight tensor.

12. The method of claim 11, wherein the one or more trainable low-rank tensors comprises a first trainable matrix and a second trainable matrix, wherein a height of the first trainable matrix is smaller than a height of the input tensor or a height of the weight tensor.

13. The method of claim 12, wherein a width of the first trainable matrix is the same as a width of the input tensor, wherein a height of the second trainable matrix is the same as a width of the weight tensor.

14. The method of claim 12, wherein updating the one or more trainable low-rank tensors comprises:
updating the first trainable matrix based on a first gradient of the loss and a learning rate; and
updating the second trainable matrix based on a second gradient of the loss and the learning rate.

15. The method of claim 11, further comprising:
storing the input tensor, weight tensor, or one or more trainable low-rank tensors in a system memory that is on a separate chip from the neural processing unit; and
transferring, by a direct memory access engine, the input tensor, weight tensor, or one or more trainable low-rank tensors from the system memory to a local memory of the neural processing unit.

16. The method of claim 15, further comprising:
storing an intermediate tensor computed by the differential kernel during the forward operation into the system memory; and
transferring, by the direct memory access engine, the intermediate tensor from the system memory to the local memory of the neural processing unit for the backward operation.

17. The method of claim 11, wherein the differentiable kernel is to compute the second partial output by:
transposing the one or more trainable low-rank tensors; and
computing the second partial output from the input tensor and the transposed one or more trainable low-rank tensors.

18. An apparatus comprising:
a computer processor for executing computer program instructions; and
a non-transitory computer-readable memory storing computer program instructions executable by the computer processor to perform operations for training a neural network, the operations comprising:
providing an input tensor, a weight tensor, and one or more trainable low-rank tensors to a neural processing unit for training a layer of the neural network through a training process, the training process comprising a forward operation and a backward operation,
offloading the forward operation to a matrix multiplication (MatMul) kernel and a differentiable kernel on the neural processing unit, the MatMul kernel to compute a first partial output from the input tensor and weight tensor, the differentiable kernel to compute a second partial output from the input tensor and the one or more trainable low-rank tensors, an output tensor of the layer computed by combining the first partial output and the second partial output,
offloading the backward operation to the MatMul kernel and the differentiable kernel, the differentiable kernel to compute one or more gradients of a loss from a gradient of the output tensor,
updating the one or more trainable low-rank tensors based on the one or more gradients of the loss, and
after updating the one or more trainable low-rank tensors, modifying the layer by combining the one or more trainable low-rank tensors and the weight tensor.

19. The apparatus of claim 18, wherein the one or more trainable low-rank tensors comprises a first trainable matrix and a second trainable matrix, wherein a height of the first trainable matrix is smaller than a height of the input tensor or a height of the weight tensor.

20. The apparatus of claim 18, wherein updating the one or more trainable low-rank tensors comprises:
updating the first trainable matrix based on a first gradient of the loss and a learning rate; and
updating the second trainable matrix based on a second gradient of the loss and the learning rate.
